(19) United States
(12) Patent Application Publication
(10) Pub. No.: US 2026/0134761 A1
(43) Pub. Date: May 14, 2026

(54) GAME SYSTEM

(71) Applicant: Konami Arcade Games Co., Ltd., Tokyo (JP)

(72) Inventors: Minato TANAKA, Tokyo (JP); Nobuyuki OZEKI, Tokyo (JP); Ken SASAKI, Tokyo (JP)

(73) Assignee: Konami Arcade Games Co., Ltd., Tokyo (JP)

(21) Appl. No.: 19/443,342

(22) Filed: Jan. 8, 2026

Related U.S. Application Data
(63) Continuation of application No. PCT/JP2024/026741, filed on Jul. 26, 2024.

(30) Foreign Application Priority Data
Aug. 1, 2023 (JP) 2023-125807

(51) Int. Cl. G07F 17/38; G07F 17/32

(52) U.S. Cl. CPC G07F 17/38; G07F 17/3297

(57) ABSTRACT

A game system includes a playing field on which a plate-shaped first game object and a plate-shaped second game object differing in shape from the first game object are to be placed, a guide configured to cause the first game object and the second game object dropped from the playing field to fall in an orientation along a vertical direction, and a first sorter provided in a path through which the first game object and the second game object fall under guidance of the guide and configured to prevent the first game object from falling and allow the second game object to pass through.

### CROSS REFERENCE TO RELATED APPLICATIONS

This application is a Continuation Application of PCT Application No. PCT/JP2024/026741, filed on Jul. 26, 2024, and is based on, and claims priority from, Japanese Patent Application No. 2023-125807, filed on Aug. 1, 2023, the entire contents of each of which are incorporated herein by reference.

### BACKGROUND

### Field of the Invention

This disclosure relates to games.

### Related Art

There have been conventionally proposed various types of games in which different types of game objects that differ in shape are used. For example, Non-Patent Document 1 (I WON THE MARVEL AVENGERS ARCADE JACKPOT!!! (NEW COIN PUSHER), [online], [Search on Jul. 23, 2023], internet, <URL: https://www.youtube.com/watch?v=XeRxm9GU6yg>) discloses a game system in which disc-shaped medals and plate-shaped cards are caused to fall from a table. In a configuration disclosed in Non-Patent Document 1, a conveyor mechanism is provided for conveying, in a horizontal direction, medals and cards dropped from the table. In a game in which different types of game objects are used, it is necessary to sort each of the game objects. In a technique disclosed in Non-Patent Document 1, since medals and cards dropped from the table are conveyed in the horizontal direction to be sorted, it takes a long time for the cards to be discharged from a discharge port so as to be allowed to be acquired by a player, for example.

### SUMMARY

In view of the circumstances described above, an object of an aspect of this disclosure is to sort different types of game objects promptly.

To solve the above problems, a game system according to an aspect of this disclosure includes a playing field on which a plate-shaped first game object and a plate-shaped second game object differing in shape from the first game object are to be placed, a guide configured to cause the first game object and the second game object dropped from the playing field to fall in an orientation along a vertical direction, and a first sorter provided in a path through which the first game object and the second game object fall under guidance of the guide and configured to prevent the first game object from falling and allow the second game object to pass through.

### BRIEF DESCRIPTION OF THE DRAWINGS

FIG. 1 is a plan view of a game system according to a first embodiment.

FIG. 2 is a block diagram showing an example of a configuration of the game system.

FIG. 3 is a plan view of a station.

FIG. 4 is an explanatory diagram showing each game object.

FIG. 5 is a side view of a handling mechanism.

FIG. 6 is a front view of the handling mechanism.

FIG. 7 is a plan view of a sorter.

FIG. 8 is an explanatory diagram showing a comparative example.

FIG. 9 is a flowchart showing processing relating to a usual game.

FIG. 10 is a schematic diagram showing an image displayed in the usual game.

FIG. 11 is a flowchart showing processing relating to a special game.

FIG. 12 is a schematic diagram showing an image displayed in the special game.

FIG. 13 is a perspective view of an example of a configuration of an accommodation mechanism.

FIG. 14 is a side view of the accommodation mechanism.

FIG. 15 is an explanatory diagram showing states of the accommodation mechanism.

FIG. 16 is a perspective view of the inside of the accommodation mechanism in an accommodation state.

FIG. 17 is a front view of a handling mechanism according to a second embodiment.

FIG. 18 is a plan view of a sorter according to the second embodiment.

FIG. 19 is a side view of a handling mechanism according to a third embodiment.

FIG. 20 is a front view of the handling mechanism according to the third embodiment.

FIG. 21 is a side view of a handling mechanism according to a fourth embodiment.

FIG. 22 is a side view of the handling mechanism according to the fourth embodiment.

FIG. 23 is a plan view of a game system according to the fourth embodiment.

FIG. 24 is a front view of a handling mechanism in a modification.

FIG. 25 is a side view of a handling mechanism in a modification.

FIG. 26 shows a plan view and a side view of a handling mechanism in a modification.

FIG. 27 is a perspective view of an accommodation mechanism in a modification.

### DESCRIPTION OF EMBODIMENTS

Embodiments according to this disclosure will be described with reference to the drawings. The embodiments described below include a variety of limitations not essential to this disclosure. Thus, the scope of this disclosure is not limited to the embodiments described below.

### First Embodiment

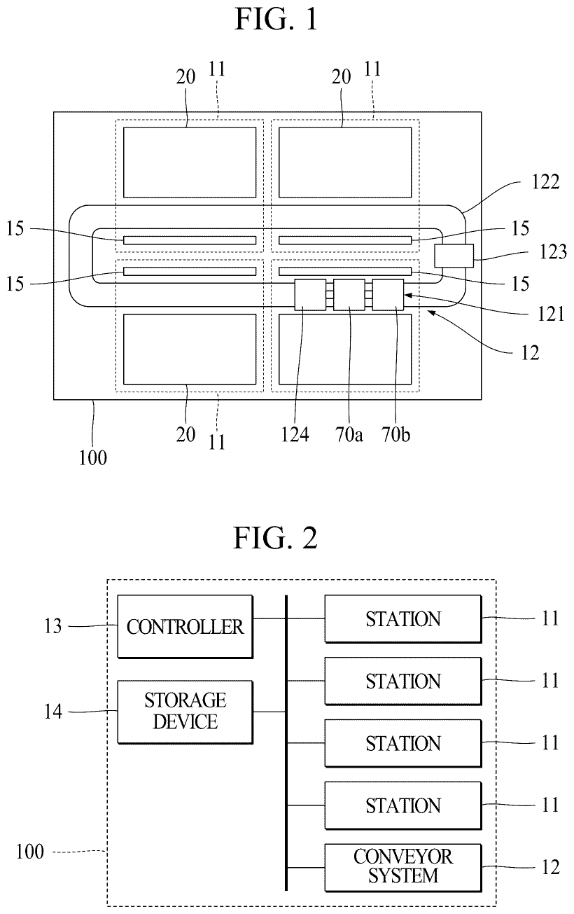

FIG. 1 is a plan view of a game system 100 according to a first embodiment of this disclosure. The game system 100 is provided in an amusement facility, for example. The amusement facility is an entertainment facility, such as an amusement arcade or a casino, or a commercial facility such as a shopping center, for example. The game system 100 provides games for players in the amusement facility.

As shown in FIG. 1, the game system 100 according to the first embodiment includes multiple (four) stations 11 and a conveyor system 12. Each of the multiple stations 11 is a unit to be used by a player to play games. In the multiple stations 11, games are progressed in parallel by different players. It should be noted that in FIG. 1, the four stations 11 are shown; however, the number of stations 11 may be freely selected.

FIG. 2 is a block diagram showing an example of a configuration of the game system 100. The game system 100 according to the first embodiment includes a controller 13 and a storage device 14 in addition to the multiple stations 11 and the conveyor system 12. It should be noted that the game system 100 may be realized by a single device or may be realized by a plurality of separate devices.

The controller 13 is constituted of one or more processors configured to control each element of the game system 100. For example, the controller 13 may be constituted of one or more types of processors such as a central processing unit (CPU), a graphics processing unit (GPU), a sound processing unit (SPU), a digital signal processor (DSP), a field programmable gate array (FPGA), or an application specific integrated circuit (ASIC). It should be noted that some or all of the functions of the controller 13 may be provided in each of the stations 11.

The storage device 14 comprises one or more memories configured to store a program to be executed by the controller 13, and a variety of types of data to be used by the controller 13. The storage device 14 is constituted of a known recording medium such as a magnetic recording medium or a semiconductor recording medium, for example. The storage device 14 may be constituted of a combination of different types of recording media. In addition, a portable recording medium detachable from the game system 100 or a recording medium (for example, a cloud storage server) that is accessible by the controller 13 via a communication network may be used as the storage device 14.

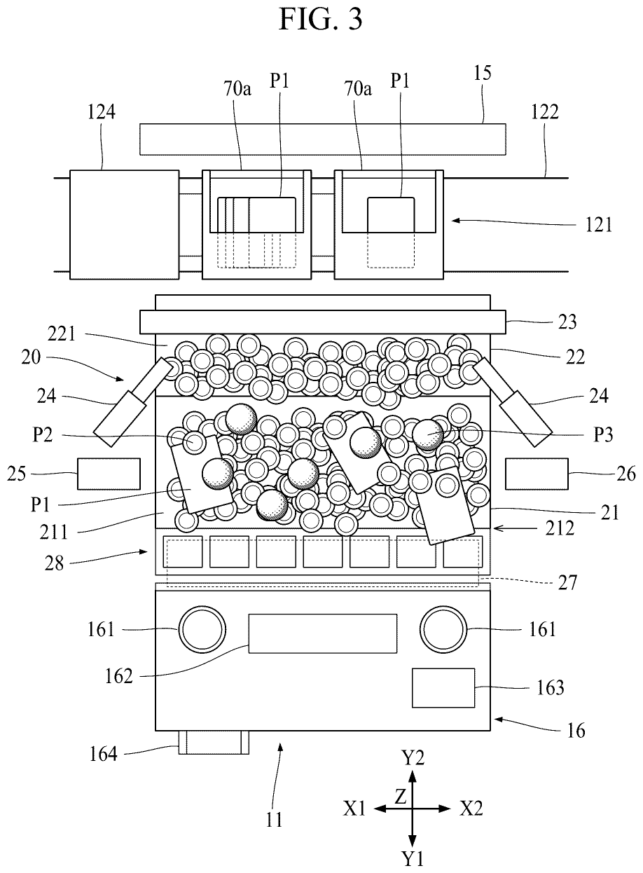

FIG. 3 is a plan view of a station 11 that is any one of the multiple stations 11. It should be noted that in the following description, three axes (an X-axis, a Y-axis, a Z-axis) perpendicular to one another are assumed. The X-axis and the Y-axis are axes along a horizontal direction. Specifically, the X-axis is an axis along a direction from a left side of a player to a right side of the player, and the Y-axis is an axis along a direction from a front side of the player to a back side of the player. The Z-axis is an axis along a vertical direction. In addition, a direction along the X-axis is referred to as “direction X1,” and a direction opposite to the direction X1 is referred to as “direction X2.” Similarly, a direction along the Y-axis is referred to as “direction Y1,” and a direction opposite to the direction Y1 is referred to as “direction Y2.”

As shown in FIG. 3, the station 11 according to the first embodiment includes a display 15, an operation unit 16, and a game mechanism 20. It should be noted that each of the multiple stations 11 may be realized by a single device or may be realized by a plurality of separate devices.

The display 15 displays images under the control of the controller 13. The display 15 is constituted of a display panel such as a liquid crystal panel or an organic EL (Electroluminescent) panel, for example. It should be noted that in FIG. 1, displays 15 of two adjacent stations 11 may be constituted of a single display panel.

In FIG. 3, the operation unit 16 is an interface for receiving operations by the player. Specifically, the operation unit 16 includes operation devices 161, a reception device 162, a payout device 163, and a discharge port 164. The operation devices 161 are input devices for receiving instructions from the player. The operation devices 161 are elements that are operable by the user, or touch panels for detecting contact made by the user, for example.

The reception device 162 receives game medals P2 from the player. The game medals P2 are disc-shaped game objects P (coins, tokens) to be used for games. For example, the reception device 162 includes an insertion port into which a game medal P2 is to be inserted, and a detector for detecting the game medal P2 inserted into the insertion port. It should be noted that the reception device 162 may receive electronic medals from the player. The payout device 163 pays out game medals P2 to the player. For example, the payout device 163 includes a storage container for storing game medals P2, and a discharge mechanism for sequentially discharging game medals P2 included in the storage container. The discharge port 164 is an opening from which game cards P1 described below are discharged.

The game mechanism 20 is a mechanism for providing the player with the games. Specifically, the game mechanism 20 according to the first embodiment provides the player with a pusher game. The game mechanism 20 includes a fixed table 21, a movable table 22, a fixed wall 23, feeding mechanisms 24, a feeding device 25, a feeding device 26, a detection device 27, and a handling mechanism 28.

The fixed table 21 is a plate-shaped structure including a playing field 211. The playing field 211 is a surface substantially parallel to an X-Y plane (i.e., a horizontal plane). The playing field 211 includes a tip end 212. The tip end 212 is a peripheral edge of the fixed table 21 in the direction Y1 and extends along the X-axis. In the direction Y1 from the tip end 212, an elongated opening along the X-axis is provided. As described above, each of the multiple stations 11 includes the playing field 211.

The movable table 22 is a stand-shaped structure including a mounting surface 221. The mounting surface 221 is a surface substantially parallel to the X-Y plane (i.e., the horizontal plane). The movable table 22 reciprocates on the playing field 211 along a direction of the Y-axis. It should be noted that the playing field 211 and the mounting surface 221 are not limited to horizontal planes. For example, one or both of the playing field 211 and the mounting surface 221 may be flat surfaces inclined relative to the horizontal plane or may be curved surfaces that are curved three-dimensionally. On the playing field 211 and the mounting surface 221, a plurality of game objects P (P1, P2, P3) is to be placed. The plurality of game objects P includes a game card P1, a game medal P2, and a game ball P3. The game card P1 is an example of a “first game object,” the game medal P2 is an example of a “second game object,” and the game ball P3 is an example of a “third game object.”

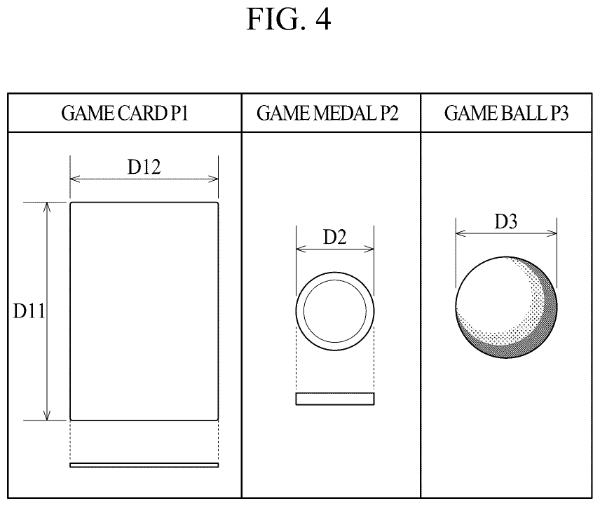

FIG. 4 is an explanatory diagram showing each game object P. As shown in FIG. 4, the game card P1, the game medal P2, and the game ball P3 differ in shape. The game card P1 is a plate-shaped card that is shaped to be substantially rectangular. For example, as an example of the game card P1, a trading card on which an image such as a famous person or a character is drawn is given. The game medal P2 is a disc-shaped game object P as described above. The game ball P3 is a rollable sphere. It should be noted that in the following explanation, regarding each of the game card P1 and the game medal P2, a direction perpendicular to a direction of thickness may be referred to as an “in-plane direction.” In other words, regarding each of the game card P1 and the game medal P2, the in-plane direction is a direction parallel to a plate surface.

A size of the game card P1 is greater than a size of the game medal P2. Specifically, a dimension of a long side of the game card P1 (hereinafter referred to as a “long side length”) D11 and a dimension of a short side of the game card P1 (hereinafter referred to as a “short side length”) D12 are each greater than a diameter D2 of the game medal P2. In addition, the size of the game card P1 is greater than a size of the game ball P3. Specifically, the long side length D11 and the short side length D12 of the game card P1 are each greater than a diameter D3 of the game ball P3. A relationship between the diameter D2 of the game medal P2 and the diameter D3 of the game ball P3 may be freely selected. In other words, a configuration in which the diameter D2 is greater than the diameter D3, a configuration in which the diameter D2 is less than the diameter D3, and a configuration in which the diameter D2 and the diameter D3 are the same are assumed.

In FIG. 3, the fixed wall 23 is a structure facing the mounting surface 221 of the movable table 22. Game objects P (P1, P2, P3) placed on the mounting surface 221 are pressed by the fixed wall 23 in the direction Y1 when the movable table 22 moves in the direction Y2. Due to the fixed wall 23 pressing, a plurality of game objects P falls from the mounting surface 221.

In addition, game objects P placed on the playing field 211 of the fixed table 21 are pressed by the movable table 22 to be moved in the direction Y1 and finally fall from the tip end 212. As described above, the game mechanism 20 according to the first embodiment is a mechanism for causing a plurality of game objects P (P1, P2, P3) placed on the playing field 211 to fall from the tip end 212. In other words, according to the first embodiment, a pusher game is realized in which different types of game objects P (P1, P2, P3) fall from the playing field 211 due to reciprocation of the movable table 22.

The feeding mechanisms 24 are mechanisms for feeding game medals P2 to the playing field 211 or to the mounting surface 221 in accordance with instructions of the player. For example, game medals P2 received by the reception device 162 from the player are fed by the feeding mechanisms 24 to the playing field 211. A point in time at which, and a direction in which, the feeding mechanisms 24 feed a game medal P2 are controlled in accordance with an instruction of the player to the operation devices 161. The feeding device 25 feeds game medals P2 to the playing field 211 or to the mounting surface 221 in accordance with progress of the game. The feeding device 26 feeds game balls P3 to the playing field 211 or to the mounting surface 221 in accordance with the progress of the game.

The detection device 27 is a sensor for detecting game medals P2 and game balls P3 dropped from the playing field 211. For example, the detection device 27 includes a sensor for detecting the game medals P2, and a sensor for detecting the game balls P3. It should be noted that the detection device 27 may also detect game cards P1.

### Handling Mechanism 28

The handling mechanism 28 is a mechanism configured to sort a plurality of game objects P dropped from the playing field 211 into game cards P1, game medals P2, and game balls P3. According to the first embodiment, a game card P1, a game medal P2, and a game ball P3 are sorted from one another; thus, it is possible to realize a variety of games in which a game card P1, a game medal P2, and a game ball P3 are used. The detection device 27 detects the game medals P2 and the game balls P3 sorted by the handling mechanism 28 from each other.

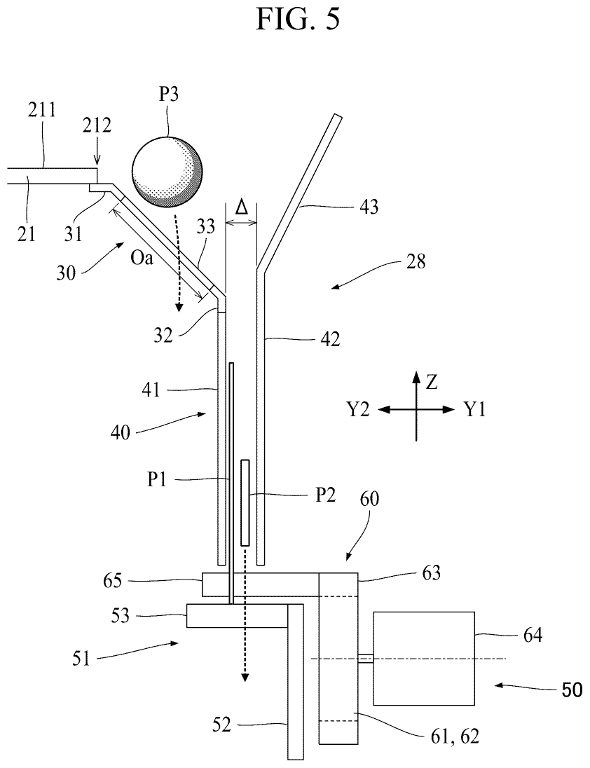

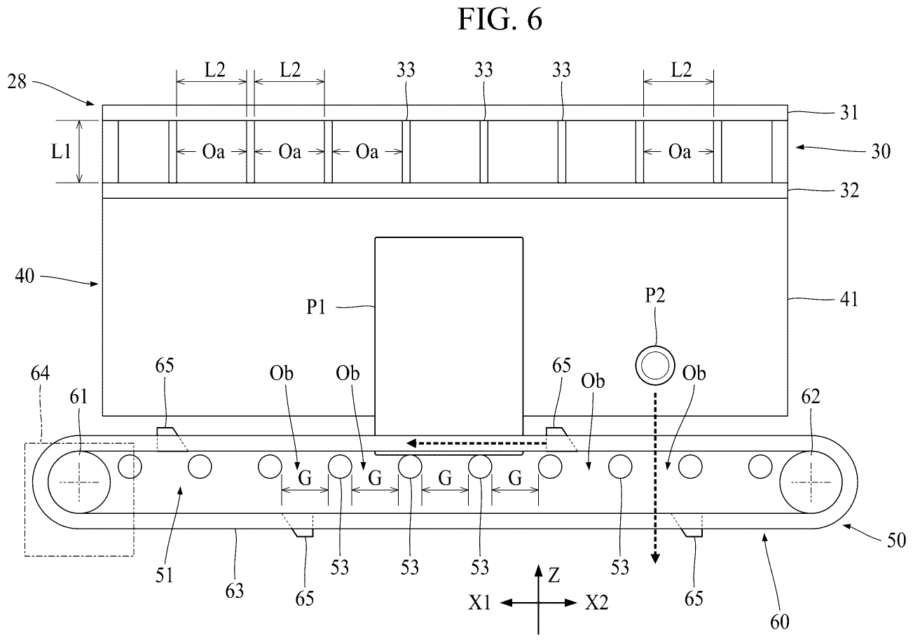

FIG. 5 is a side view of the handling mechanism 28. FIG. 6 is a front view of the handling mechanism 28. As shown in FIG. 5 and FIG. 6, the handling mechanism 28 according to the first embodiment includes a sorter 30, a guide 40, and a sorter 50. The guide 40 is provided directly below the tip end 212 of the playing field 211. The sorter 30 is provided between the playing field 211 and the guide 40, and the sorter 50 is provided directly below the guide 40. In other words, the guide 40 is disposed between the sorter 30 and the sorter 50. The sorter 30 is an example of a “second sorter,” and the sorter 50 is an example of a “first sorter.”

A game object P dropped from the playing field 211 reaches the sorter 30. As shown in FIG. 6, the sorter 30 is an elongated structure extending over the entire portion of the playing field 211 that is along a direction of the X-axis (i.e., the full width). Specifically, the sorter 30 includes a horizontal shaft 31, a horizontal shaft 32, and a plurality of vertical shafts 33.

The horizontal shaft 31 and the horizontal shaft 32 are members extending in the direction of the X-axis. The horizontal shaft 31 and the horizontal shaft 32 are provided in parallel to, and at a predetermined distance from, each other. The plurality of vertical shafts 33 are rod-shaped members connecting the horizontal shaft 31 and the horizontal shaft 32 to each other. The plurality of vertical shafts 33 are provided spaced apart from one another in the direction of the X-axis. The horizontal shaft 32 is at a lower level compared to the horizontal shaft 31. Thus, each of the plurality of vertical shafts 33 is inclined relative to the vertical direction such that one end of a vertical shaft 33 close to the guide 40 is disposed at a lower level compared to the other end of the vertical shaft 33 close to the playing field 211.

The sorter 30 is provided with a plurality of openings Oa. Each of the plurality of openings Oa is a rectangular space surrounded by the horizontal shaft 31, the horizontal shaft 32, and two adjacent vertical shafts 33 in the direction of the X-axis. The plurality of openings Oa are aligned in the direction of the X-axis.

A vertical dimension L1 of each of the plurality of openings Oa corresponds to a distance between the horizontal shaft 31 and the horizontal shaft 32. A horizontal dimension L2 of each of the plurality of openings Oa corresponds to a distance between two adjacent vertical shafts 33 in the direction of the X-axis. The dimension L1 and the dimension L2 of each of the plurality of openings Oa are each less than each of the long side length D11 and the short side length D12 of a game card P1. In addition, a dimension of a diagonal line of an opening Oa is less than the short side length D12 of the game card P1. In addition, the dimension L1 and the dimension L2 of each of the plurality of openings Oa are each greater than each of the diameter D2 of a game medal P2 and the diameter D3 of a game ball P3.

Thus, as shown in FIG. 5, the game ball P3 passes through an opening Oa of the sorter 30 to fall downward in the vertical direction. On the other hand, the game card P1 cannot pass through any of the openings Oa of the sorter 30. Thus, the game card P1 moves along each of the plurality of vertical shafts 33 to reach the guide 40. In addition, some game medals P2 among a plurality of game medals P2 pass fall through openings Oa of the sorter 30 to fall, and the remaining game medals P2 move along each of the plurality of vertical shafts 33 to reach the guide 40. In other words, a plurality of game cards P1 and a plurality of game medals P2 reach the guide 40. As will be understood from the above description, the sorter 30 is an element for sorting game balls P3 (and game medals P2) included in a plurality of game objects P.

The guide 40 is a guide mechanism for guiding a game card P1 and a game medal P2 provided by the sorter 30. Specifically, the guide 40 causes the game card P1 and the game medal P2 to fall in an orientation along the vertical direction. The orientation along the vertical direction denotes a state in which an angle of the in-plane direction of each of the game card P1 and the game medal P2 relative to the vertical direction is 45° or less (more particularly 30° or less), for example.

As shown in FIG. 5, the guide 40 according to the first embodiment includes a first wall member 41, a second wall member 42, and a third wall member 43. The first wall member 41, the second wall member 42, and the third wall member 43 extend over the entire portion of the playing field 211 that is along the direction of the X-axis (i.e., the full width). It should be noted that in FIG. 6, the second wall member 42 and the third wall member 43 are omitted for convenience.

As shown in FIG. 5, the first wall member 41 and the second wall member 42 are plate-shaped members along the vertical direction. Specifically, the first wall member 41 and the second wall member 42 are supported in an orientation of being parallel to each other along an XZ plane. The first wall member 41 is a wall-shaped structure extending downward in the vertical direction from a lower end (the horizontal shaft 32) of the sorter 30. The second wall member 42 faces the first wall member 41 at a predetermined distance Δ.

An upper end of the second wall member 42 is higher than an upper end of the first wall member 41 (the lower end of the sorter 30). The third wall member 43 is a plate-shaped member continuous with the upper end of the second wall member 42. The third wall member 43 is inclined relative to the second wall member 42 (the vertical direction). Specifically, an upper end of the third wall member 43 is disposed in the direction Y1 compared to a lower end of the third wall member 43.

In the configuration described above, the game card P1 and the game medal P2 provided by the sorter 30 fall in a space between the first wall member 41 and the second wall member 42. Specifically, the game card P1 and the game medal P2 having reached the guide 40 from the sorter 30 collide with the third wall member 43 to turn downward in the vertical direction and fall in the space between the first wall member 41 and the second wall member 42. It should be noted that another game card P1 and another game medal P2 may fall in the space between the first wall member 41 and the second wall member 42 without colliding with the third wall member 43.

The distance Δ between the first wall member 41 and the second wall member 42 is less than each of the long side length D11 and the short side length D12 of a game card P1. In addition, the distance Δ between the first wall member 41 and the second wall member 42 is less than the diameter D2 of a game medal P2. For example, the distance Δ is set to a dimension of approximately half of the diameter D2 of the game medal P2. Thus, a game card P1 and a game medal P2 falling between the first wall member 41 and the second wall member 42 cannot turn to being in an orientation along the horizontal direction (sideways). In other words, the game card P1 and the game medal P2 fall while being in the orientation along the vertical direction. Specifically, the game card P1 and the game medal P2 fall in an orientation along the XZ plane. As described above, the guide 40 functions as a guide for limiting an orientation of each of the game card P1 and the game medal P2 to the orientation along the vertical direction.

The sorter 50 is provided in a path through which the game card P1 and the game medal P2 fall under guidance of the guide 40. In other words, the game card P1 and the game medal P2 reach the sorter 50 while being in the orientation along the vertical direction. The sorter 50 is a mechanism for sorting the game card P1 from the game medal P2. Specifically, the sorter 50 prevents the game card P1 from falling and allows the game medal P2 to pass through.

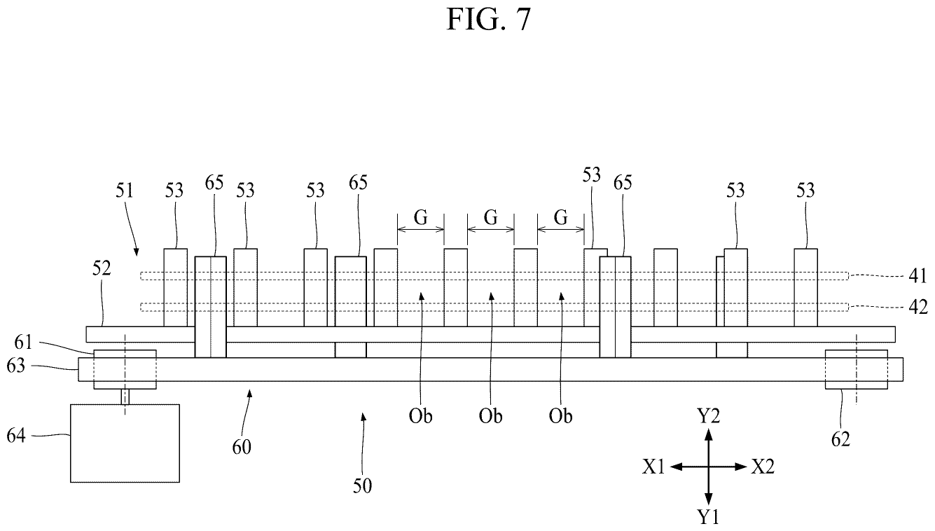

FIG. 7 is a plan view of the sorter 50. As shown in FIG. 5 to FIG. 7, the sorter 50 according to the first embodiment includes a sorting mechanism 51 and a conveyor mechanism 60. The conveyor mechanism 60 is provided in the direction Y1 from the sorting mechanism 51.

The sorting mechanism 51 includes a fixed plate 52 and a plurality of support members 53. The fixed plate 52 is a plate-shaped structure supporting the plurality of support members 53. The plurality of support members 53 are aligned in the direction of the X-axis at intervals G. The plurality of support members 53 are aligned over the entire portion of the playing field 211 that is along the direction of the X-axis (i.e., the full width). Each of the plurality of support members 53 is a cylindrical member with a central axis along the Y-axis. As shown in FIG. 5, a lower end of the first wall member 41 is disposed in a vicinity of a tip end of each of the plurality of support members 53. It should be noted that shapes of the support members 53 may be freely selected. For example, prismatic support members 53 may be provided.

As described above, in the guide 40, a game card P1 falls in the orientation along the XZ plane. In other words, an in-plane direction of the game card P1 having reached the sorting mechanism 51 and a direction of a central axis of each of the support members 53 intersect each other (typically, at a right angle). Thus, as shown in FIG. 5 and FIG. 6, a lower end of the game card P1 having reached the sorting mechanism 51 collides with side surfaces of support members 53.

As shown in FIG. 6 and FIG. 7, a plurality of openings Ob is formed by the plurality of support members 53. An opening Ob is a space between two adjacent support members 53 in the direction of the X-axis. The plurality of openings Ob is provided over the entire portion of the playing field 211 that is along the direction of the X-axis (i.e., the full width).

The distance G between two adjacent support members 53 denotes a dimension of an opening Ob in the direction of the X-axis. The distance G between the respective support members 53 is less than each of the long side length D11 and the short side length D12 of a game card P1. Thus, the game card P1 having reached the sorting mechanism 51 cannot pass through any of the openings Ob but is supported by support members 53. For example, as shown in FIG. 5 and FIG. 6, the game card P1 is supported by two or more support members 53 while being in an orientation along the vertical direction. As described above, the plurality of support members 53 is a structure for supporting the game card P1 from below. In addition, the expression: “the game card P1 is caught by the plurality of support members 53” may be applied.

In addition, the distance G between the respective support members 53 is greater than the diameter D2 of a game medal P2. Thus, as shown in FIG. 6, game medals P2 pass through the respective openings Ob to fall. As described above, the sorting mechanism 51 according to the first embodiment includes the openings Ob each having a size less than a size (D11, D12) of a game card P1 and greater than a size (D2) of a game medal P2. In addition, the sorting mechanism 51 sorts a game card P1 from a game medal P2 by allowing only the game medal P2, which is among the game card P1 and the game medal P2, to selectively pass through.

As described above, the sorter 50 sorts the game card P1 from the game medal P2 depending on whether there is a size allowed to pass through an opening Ob. Thus, by a simple configuration in which power is not required, it is possible to sort the game card P1 from the game medal P2 with high accuracy. In addition, by a simple configuration in which the plurality of support members 53 are provided spaced apart from one another, it is possible to form the openings Ob for sorting the game card P1 from the game medal P2.

The conveyor mechanism 60 is a mechanism for conveying, for the discharge port 164 of the operation unit 16, a game card P1 prevented from falling by the sorting mechanism 51. Specifically, the conveyor mechanism 60 conveys the game card P1 supported by the support members 53 in the direction of the X-axis. As shown in FIG. 6 and FIG. 7, the conveyor mechanism 60 according to the first embodiment includes a rotation axis 61, a rotation axis 62, an annular body 63, a driver device 64, and a plurality of press members 65.

The rotation axis 61 and the rotation axis 62 are cylindrical rotors provided spaced apart from each other in the direction of the X-axis. The rotation axis 61 and the rotation axis 62 are provided such that their central axes are along the Y-axis. The annular body 63 is an annular (specifically elliptical) power transmission member wound around the rotation axis 61 and the rotation axis 62. For example, as the annular body 63, a deformable machine element such as a chain or a belt may be used. The annular body 63 extends over the entire portion of the playing field 211 that is along the direction of the X axis (i.e., the full width).

The driver device 64 is an electric motor for rotating the rotation axis 61. Rotation of the rotation axis 61 causes the annular body 63 to rotate. Thus, an upper straight section (hereinafter referred to as a “conveying section”) of the annular body 63 moves in the direction X1. It should be noted that in addition to the driver device 64 for rotating the rotation axis 61, another driver device 64 for rotating the rotation axis 62 may be provided.

The plurality of press members 65 are structures provided at different portions of the annular body 63 in a circumferential direction. Each of the plurality of press members 65 is an elongated member protruding in the direction Y2 from a side surface of the annular body 63. Each of the plurality of press members 65 moves in conjunction with the rotation of the annular body 63. For example, a press member 65 disposed in the conveying section of the annular body 63 moves in the direction X1 in conjunction with rotation of the annular body 63.

Each of the plurality of press members 65 passes over an array of the plurality of support members 53. Thus, a press member 65 that is in the conveying section presses a game card P1, which is supported by the plurality of support members 53, in the direction X1. A vertical distance between the support members 53 and the press member 65 is less than the short side length D12 of the game card P1 (i.e., a minimum value of outer dimensions of the game card P1). Thus, even when the game card P1 long sides of which face in the horizontal direction is supported by the support members 53, the press member 65 can reliably press the game card P1. As described above, the conveyor mechanism 60 conveys the game card P1 supported by the plurality of support members 53 in the direction X1.

The game card P1 conveyed by the conveyor mechanism 60 reaches an end of the sorting mechanism 51 in the direction X1. After reaching the end of the sorting mechanism 51, the game card P1 reaches the discharge port 164 via a conveyance path (not shown). The player can acquire the game card P1 from the discharge port 164.

As described above, according to the first embodiment, a game card P1 prevented from falling by the sorter 50 is conveyed by the conveyor mechanism 60 for the discharge port 164. Thus, compared to a configuration in which no conveyor mechanism 60 is provided, it is possible to promptly discharge the game card P1 into the discharge port 164.

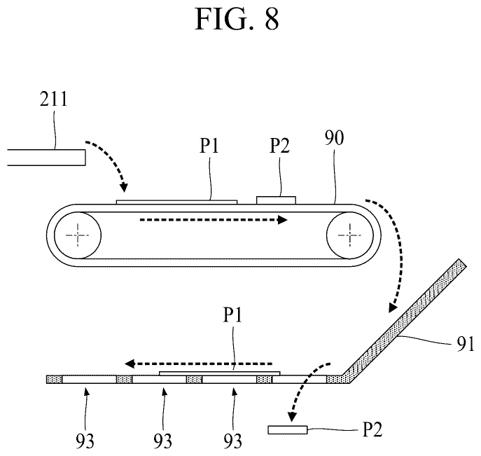

It should be noted that, as shown in FIG. 8, as a configuration in which a game card P1 is sorted from a game medal P2, a configuration (hereinafter referred to as a “comparative example”) is also assumed in which a game card P1 and a game medal P2 are conveyed in the horizontal direction to be sorted. In the comparative example, a game card P1 and a game medal P2 dropped from the playing field 211 are conveyed by the conveyor mechanism 90 in the horizontal direction to slide along an inclined surface 91, and then the game card P1 is sorted from the game medal P2. For example, by causing only the game medal P2 to fall from an opening 93 provided in a path, the game card P1 is sorted from the game medal P2. However, in the comparative example, it takes a certain amount of time from a point in time of falling from the playing field 211 to a point in time of the sorting; thus, a longer time is required from a point in time of falling of the game card P1 to a point in time at which a player can actually acquire the game card P1.

In contrast to the comparative example, according to the first embodiment, with falling of a game card P1 and a game medal P2 that are in an orientation along the vertical direction, the game card P1 is sorted by the sorter 50 from the game medal P2. Thus, compared to the comparative example in which a game card P1 and a game medal P2 are conveyed in the horizontal direction to be sorted, it is possible to promptly sort the game card P1 from the game medal P2. In other words, it is possible to shorten time from a point in time of falling of the game card P1 to a point in time at which the player can actually acquire the game card P1.

Furthermore, in the comparative example, a game medal P2 may be conveyed while being placed on a game card P1. The game medal P2 placed on the game card P1 does not fall from any of openings 93 provided in the path; as a result, the game medal P2 is discharged together with the game card P1. In other words, in the comparative example, there is a problem in that a game card P1 is sorted from a game medal P2 with low accuracy. In contrast to the comparative example, according to the first embodiment, in an orientation along the vertical direction, a game card P1 is sorted from a game medal P2; thus, it is possible to reduce a probability that the game medal P2 is placed on the game card P1. Thus, compared to the comparative example, it is possible to sort a game card P1 from a game medal P2 with high accuracy.

In FIG. 1, the conveyor system 12 is a mechanism for conveying game cards P1 to each of the multiple stations 11. Specifically, the conveyor system 12 includes a movable body 121, a conveyance path 122, and a feeding device 123. The movable body 121 moves along the conveyance path 122 under the control of the controller 13. The conveyance path 122 is annularly provided such that the movable body 121 visits the multiple stations 11 one by one.

The movable body 121 includes a conveyor mechanism 124, an accommodation mechanism 70a, and an accommodation mechanism 70b, for example. The conveyor mechanism 124 conveys the accommodation mechanism 70a and the accommodation mechanism 70b. For example, the conveyor mechanism 124 uses a power source, such as an electric motor, to tow the accommodation mechanism 70a and the accommodation mechanism 70b along the conveyance path 122. The conveyor mechanism 124 according to the first embodiment conveys the accommodation mechanism 70a and the accommodation mechanism 70b to each of the multiple stations 11. The accommodation mechanism 70a and the accommodation mechanism 70b are hollow housings capable of accommodating game cards P1 and of discharging the game cards P1.

The feeding device 123 feeds game cards P1 to the accommodation mechanism 70a or to the accommodation mechanism 70b under the control of the controller 13. In a state in which the movable body 121 is close to the feeding device 123, game cards P1 are fed by the feeding device 123 to the accommodation mechanism 70a or the accommodation mechanism 70b, and in a state in which the movable body 121 is close to a station 11, the game cards P1 are discharged from the accommodation mechanism 70a or the accommodation mechanism 70b to the playing field 211.

As described above, according to the first embodiment, since the accommodation mechanism 70a and the accommodation mechanism 70b are conveyed to each of the multiple stations 11, it is unnecessary to provide the accommodation mechanism 70a, the accommodation mechanism 70b, and the feeding device 123 for each of the multiple stations 11 individually. Thus, compared to a configuration in which the accommodation mechanism 70a, the accommodation mechanism 70b, and the feeding device 123 are provided for each of the multiple stations 11 individually, it is possible to simplify the configuration of the game system 100.

### Progress of Game

Games executed by the game system 100 will be described. The game system 100 according to the first embodiment provides a usual game and a special game for a player at each of the multiple stations 11. The usual game is a game that is to be steadily played at each of the multiple stations 11. The special game is a game through which the player can acquire a large number of game cards P1. The special game is executed at a station 11, at which a specific condition is satisfied, among the multiple stations 11. The controller 13 controls progress of the usual game and of the special game. The controller 13 is an example of a “controller.”

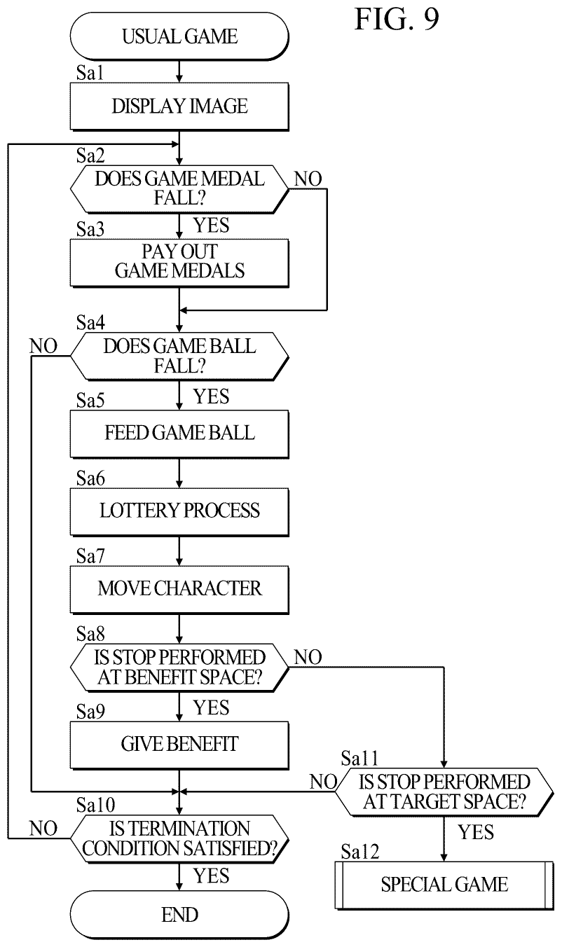

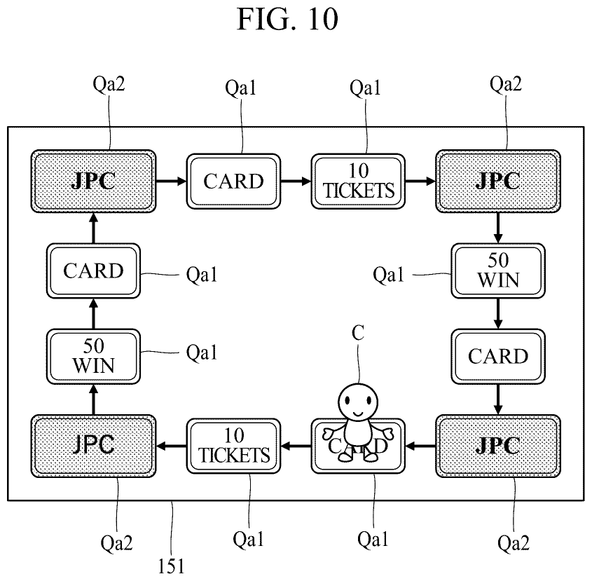

FIG. 9 is a flowchart showing processing executed by the controller 13 in the usual game. When the usual game starts, the controller 13 displays an image 151 shown in FIG. 10 on the display 15 (Sa1). In the image 151, a plurality of spaces Qa (Qa1, Qa2) is displayed. The usual game is a board game (Sugoroku) in which a character C is moved along a sequence of the plurality of spaces Qa. Each of the plurality of spaces Qa is a point at which the character C can stop. The plurality of spaces Qa includes benefit spaces Qa1 and target spaces Qa2.

The controller 13 determines whether a game medal P2 falls from the playing field 211 (Sa2). When a game medal P2 falls (Sa2: YES), the controller 13 pays out a predetermined quantity of game medals P2 to the player from the payout device 163 (Sa3). When no game medals P2 fall (Sa2: NO), no game medals P2 are paid out (Sa3).

The controller 13 determines whether a game ball P3 falls from the playing field 211 (Sa4). When a game ball P3 falls (Sa4: YES), the controller 13 controls the feeding device 26 to feed another game ball P3 to the playing field 211 (Sa5). As described above, each time a game ball P3 falls, another game ball P3 is supplied; thus, a predetermined number of game balls P3 are constantly maintained in the playing fields 211.

The controller 13 determines an amount of movement of the character C by a lottery process (Sa6). The lottery process is a process of selecting, as the amount of movement, a candidate value from a plurality of candidate values (for example, one to six). For example, as an example of the lottery process, a physical lottery for randomly selecting a candidate value from the plurality of candidate values by a physical lottery mechanism, or an electronic lottery for randomly selecting a candidate value from the plurality of candidate values by an arithmetic process may be given. The controller 13 moves the character C by the amount of movement determined by the lottery process (Sa7).

The controller 13 determines whether the character C stops at a benefit space Qa1 (Sa8). When the character C stops at a benefit space Qa1 (Sa8: YES), the controller 13 gives the player a benefit described below (Sa9). Benefit A1: a predetermined number of game medals P2 is fed by the feeding device 25 to the playing field 211 (for example, “50 WIN”). Benefit A2: a predetermined number of game cards P1 is fed by the conveyor system 12 to the playing field 211 (for example, “CARD”). Benefit A3: a predetermined number of benefit tickets is given to the player (for example, “10 TICKETS”).

To give the benefit A1, the controller 13 controls the feeding device 25 to feed the predetermined number of game medals P2 to the playing field 211. To give the benefit A3, the controller 13 controls a discharge device (not shown) to discharge the predetermined number of benefit tickets. The benefit tickets are game values having values exchangeable for a specific prize, for example.

To give the benefit A2, the controller 13 controls the conveyor system 12. Specifically, the controller 13 causes the accommodation mechanism 70b to approach the feeding device 123 and causes the feeding device 123 to feed the predetermined number of game cards P1 to the accommodation mechanism 70b, and then causes the accommodation mechanism 70b to approach a station 11 and causes the accommodation mechanism 70b to discharge the game cards P1 to the playing field 211. As described above, the feeding device 123 feeds game cards P1 to the accommodation mechanism 70b in accordance with progress of the usual game.

The controller 13 determines whether a termination condition for the usual game is satisfied (Sa10). The termination condition denotes that an instruction to terminate the usual game is provided by the player operating the operation device 161, for example. When the termination condition is not satisfied (Sa10: NO), the controller 13 shifts processing to step Sa2. In other words, until the termination condition for the usual game is satisfied, the payout (Sa2, Sa3) of game medals P2 subject to a falling of a game medal P2 and the giving (Sa4 to Sa9) of a benefit subject to stopping at a benefit space Qa1 are repeated. When the termination condition is satisfied (Sa10: YES), the usual game terminates.

On the other hand, when the character C does not stop at any of the benefit spaces Qa1 (Sa8: NO), the controller 13 determines whether the character C stops at a target space Qa2 (Sa11). The target space Qa2 is a space Qa used as a condition for a start of the special game. When the character C does not stop at any of the benefit spaces Qa2 (Sa11: NO), the controller 13 determines whether the termination condition for the usual game is satisfied (Sa10). On the other hand, when the character C stops at a target space Qa2 (Sa11: YES), the controller 13 starts the special game (Sa12).

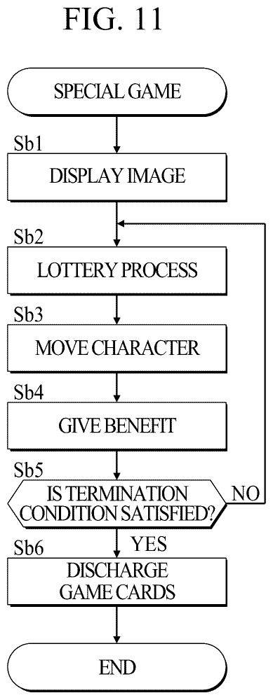

FIG. 11 is a flowchart showing processing executed by the controller 13 in the special game. When the special game starts, the controller 13 displays an image 152 shown in FIG. 12 on the display 15 (Sb1). In the image 152, a plurality of spaces Qb is displayed. The special game, as well as the usual game, is a board game (Sugoroku) in which the character C is moved along a sequence of the plurality of spaces Qb. Each of the plurality of spaces Qb is a point at which the character C can stop.

The controller 13 determines an amount of movement of the character C by a lottery process (Sb2). The lottery process is a process of selecting, as the amount of movement, a candidate value from a plurality of candidate values (for example, 1 to 6). For example, the physical lottery or the electronic lottery described above for the usual game is executed as the lottery process. The controller 13 moves the character C by the amount of movement determined by the lottery process (Sb3).

To each of the plurality of spaces Qb, a benefit is set. The controller 13 gives the player a benefit corresponding to a space Qb at which the character C stops (Sb4). The controller 13 gives the player a benefit described below, for example. Benefit B1: a predetermined number of game medals P2 is fed by the feeding device 25 to the playing field 211 (for example, “100 WIN”). Benefit B2: a predetermined number of game cards P1 is fed by the feeding device 123 to the accommodation mechanism 70a (for example “CARD+5”). Benefit B3: a predetermined number of benefit tickets is given to the player (for example, “100 TICKETS”).

To give the benefit B1, the controller 13 controls the feeding device 25 to feed the predetermined number of game medals P2 to the playing field 211. To give the benefit B3, the controller 13 controls the discharge device (not shown) to discharge the predetermined number of benefit tickets.

To give the benefit B2, the controller 13 controls the conveyor system 12. Specifically, the controller 13 causes the accommodation mechanism 70a to approach the feeding device 123 and causes the feeding device 123 to feed the predetermined number of game cards P1 to the accommodation mechanism 70a. As described above, the feeding device 123 feeds game cards P1 to the accommodation mechanism 70a in accordance with progress of the special game.

The controller 13 determines whether a termination condition for the special game is satisfied (Sb5). The termination condition denotes that in a current special game, the character C stops again at a space Qb at which a stop was performed in the past, for example. When the termination condition is not satisfied (Sb5: NO), the controller 13 shifts processing to step Sb2. In other words, until the termination condition for the special game is satisfied, the giving (Sb2 to Sb4) of a benefit to the player is repeated. By the character C repeatedly stopping at any of the spaces Qb corresponding to the benefit B2, a large number of game cards P1 is accumulated within the accommodation mechanism 70a.

When the termination condition for the special game is satisfied (Sb5: YES), the controller 13 controls the conveyor system 12 to discharge a plurality of game cards P1 accommodated within the accommodation mechanism 70a to the playing field 211 (Sb6). The game cards P1 discharged from the accommodation mechanisms 70 are spread over the playing field 211. Thus, a chance of acquiring a large number of game cards P1 is given to the player. When the game cards P1 are discharged (Sb6), the special game terminates.

### Accommodation Mechanisms 70

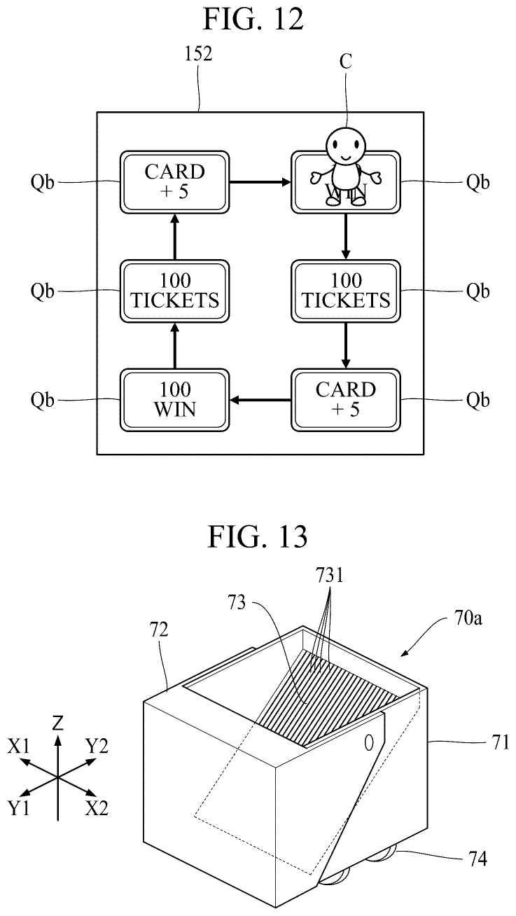

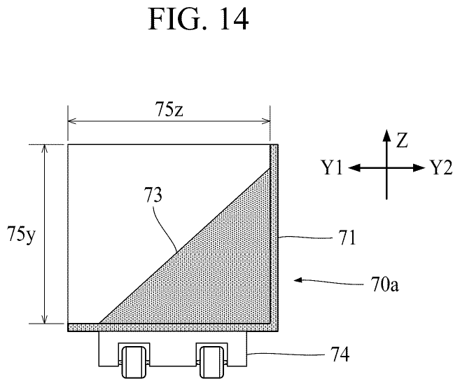

FIG. 13 is a perspective view of an example of a configuration of the accommodation mechanism 70a. FIG. 14 is a side view of the accommodation mechanism 70a. It should be noted that in practice, an orientation of the accommodation mechanism 70a may vary on the conveyance path 122 as necessary; however, in the following description, a state is assumed in which the accommodation mechanism 70a is close to a station 11, and the three axes (the X-axis, the Y-axis, the Z-axis) perpendicular to one another are used for explanation of the accommodation mechanism 70a for convenience. It should be noted that a configuration of the accommodation mechanism 70b is the same as that of the accommodation mechanism 70a; thus, explanation thereof is omitted.

The accommodation mechanism 70a includes a housing 71, a lid 72, a mounting surface 73, and a cart 74. It should be noted that in FIG. 14, the lid 72 is not shown.

The housing 71 is a box-shaped structure. As shown in FIG. 14, the housing 71 is provided with an opening 75z and an opening 75y. The opening 75z is an opening facing upward in the vertical direction. The opening 75y is an opening facing in the direction Y1. In other words, the housing 71 is a structure obtained by removing an upper surface facing upward in the vertical direction and a side surface facing in the direction Y1 from a hollow cuboid structure.

The lid 72 is a structure attached to the housing 71 by a rotation axis along the X-axis. Rotation of the lid 72 relative to the housing 71 causes the opening 75y to be switched between open and closed. On the other hand, as shown in FIG. 13, the opening 75z facing upward in the vertical direction maintains opening. Game cards P1 fed by the feeding device 123 are accommodated within the housing 71 through the opening 75z. The cart 74 is a transportation mechanism movable in a state of supporting the housing 71. The housing 71 rotates the housing 71 about an axis along the X-axis.

The mounting surface 73 is a plane provided within the housing 71. A plurality of game cards P1 accommodated within the accommodation mechanism 70a is placed on the mounting surface 73. The mounting surface 73 is inclined relative to the horizontal surface. Specifically, the mounting surface 73 is inclined relative to the horizontal surface such that an end of the mounting surface 73 in the direction Y1 is lower than an end of the mounting surface 73 in the direction Y2. As shown in FIG. 13, the mounting surface 73 is provided with a plurality of longitudinal grooves 731. Thus, compared to a configuration in which the mounting surface 73 is a flat surface, it is possible to reduce friction between game cards P1 and the mounting surface 73. However, the plurality of grooves 731 may be omitted.

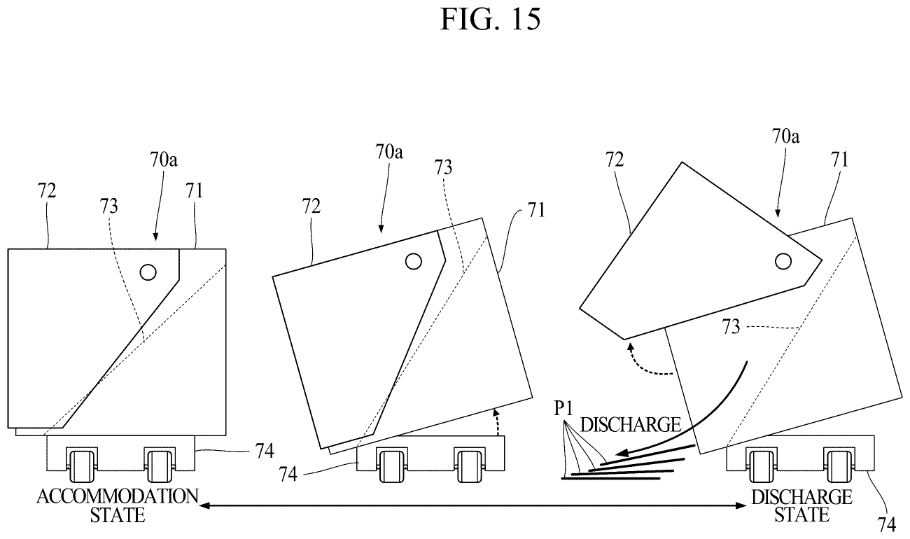

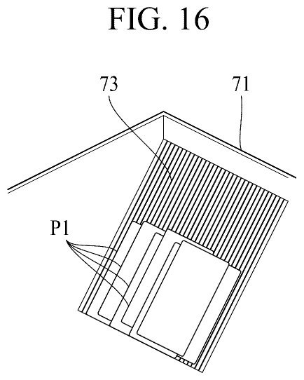

FIG. 15 is an explanatory diagram showing states of the accommodation mechanism 70a. As shown in FIG. 15, the accommodation mechanism 70a according to the first embodiment is controlled between an accommodation state and a discharge state. The accommodation state is a state in which a plurality of game cards P1 fed by the feeding device 123 is held. Specifically, in the accommodation state, a bottom surface of the housing 71 is in a state of being parallel to the horizontal surface, and the opening 75y of the housing 71 is in a state of being closed by the lid 72. The plurality of game cards P1 placed on the mounting surface 73 is held in the housing 71 by the lid 72. The lid 72 is opaque. Thus, the player cannot visually see the game cards P1 within the accommodation mechanism 70a.

FIG. 16 shows the inside of the accommodation mechanism 70a in the accommodation state. As shown in FIG. 16, in the accommodation state, each of the plurality of game cards P1 is held in the same orientation. In other words, the plurality of game cards P1 are accommodated within the accommodation mechanism 70a while being stacked in parallel to one another on the mounting surface 73. According to a configuration in which the plurality of game cards P1 are stacked as described above, compared to a configuration in which the plurality of game cards P1 are accommodated without overlapping, it is possible to reduce a size of the accommodation mechanism 70a, for example.

On the other hand, as shown in FIG. 15, the discharge state is a state of discharging the plurality of game cards P1 to the playing field 211. When the termination condition for the special game is satisfied (Sb5: YES), the controller 13 changes the accommodation mechanism 70a from being in the accommodation state to being in the discharge state to discharge the plurality of game cards P1 to the playing field 211 (Sb6).

The discharge state is a state in which the housing 71 is maintained in a state of being inclined relative to the cart 74 and the lid 72 opens the opening 75y. In the discharge state, the mounting surface 73 is maintained in a state of being inclined relative to the horizontal surface. Specifically, in the discharge state, the mounting surface 73 is inclined relative to the horizontal plane such that an end of the mounting surface 73 in the direction Y1 is lower than an end of the mounting surface 73 in the direction Y2. When the lid 72 is opened in the above state, the plurality of game cards P1 accommodated in the accommodation mechanism 70a are discharged along the mounting surface 73 in the direction Y1. After the plurality of game card P1 are discharged, the accommodation mechanism 70a changes from being in the discharge state to being in the accommodation state.

As described above, according to the first embodiment, in the accommodation state, the plurality of game cards P1 is accommodated in the accommodation mechanism 70a in the same orientation, and in the discharge state, each of the plurality of game cards P1 is discharged to the playing field 211. Thus, compared to a configuration in which the plurality of game cards P1 in different orientations are accommodated in the accommodation mechanism 70a, it is possible to forcefully discharge the plurality of game cards P1 to a wide range of the playing field 211, for example.

In particular, according to the first embodiment, the plurality of game cards P1 stacked in parallel to one another are discharged from the accommodation mechanism 70a along the mounting surface 73 inclined relative to the horizontal plane. Thus, a game card P1 slides on an upper surface of another game card P1; thus, it is possible to spread the plurality of game cards P1 to a wide range. Specifically, in the discharge state, the mounting surface 73 is inclined such that the end of the mounting surface 73 in the direction Y1 is lower than the end of the mounting surface 73 in the direction Y2. Thus, it is possible to spread the plurality of game cards P1 to an area close to the player in a wide range.

### Second Embodiment

A second embodiment will be described. It should be noted that in the descriptions of the following embodiments, elements having the same functions as in the first embodiment are denoted by the same reference numerals as used for like elements in the description of the first embodiment, and detailed description thereof is omitted, as appropriate.

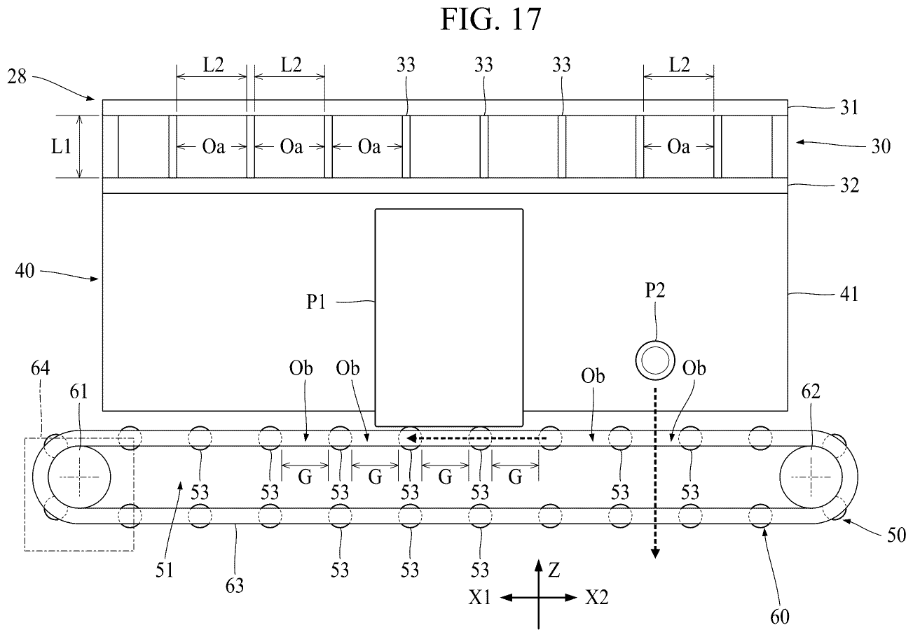

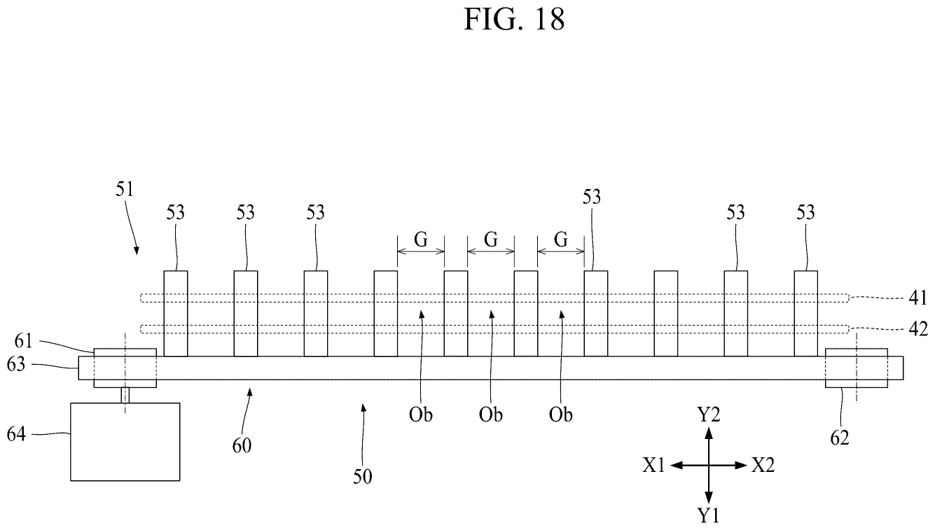

FIG. 17 is a front view of a handling mechanism 28 according to the second embodiment. FIG. 18 is a plan view of a sorter 50 according to the second embodiment. In the first embodiment, a configuration is described in which the sorter 50 includes the sorting mechanism 51 and the conveyor mechanism 60. The handling mechanism 28 according to the second embodiment differs in configuration of the sorter 50 from that of the first embodiment. Elements other than the sorter 50 are the same as those of the first embodiment.

The sorter 50 according to the second embodiment includes the sorting mechanism 51 and the conveyor mechanism 60. The sorting mechanism 51 includes the plurality of support members 53. The conveyor mechanism 60 includes the rotation axis 61, the rotation axis 62, the annular body 63, and the driver device 64. The sorter 50 according to the second embodiment has a configuration in which the press members 65 of the conveyor mechanism 60 according to the first embodiment are replaced with the plurality of support members 53 of the sorting mechanism 51. Thus, in the second embodiment, the fixed plate 52 of the sorting mechanism 51 and the press members 65 of the conveyor mechanism 60 are omitted.

Specifically, in the second embodiment, the plurality of support members 53 are provided at different portions of the annular body 63 in the circumferential direction. Each of the plurality of support members 53 protrudes in the direction Y2 from the side surface of the annular body 63. Each of the plurality of support members 53 moves in conjunction with the rotation of the annular body 63. For example, a support member 53 disposed in the conveying section of the annular body 63 moves in the direction X1 in conjunction with the rotation of the annular body 63.

The plurality of support members 53 is provided in the annular body 63 at intervals G. As in the first embodiment, the plurality of openings Ob is formed by the plurality of support members 53. The plurality of openings Ob is provided over the entire portion of the playing field 211 that is along the direction of the X-axis (i.e., the full width).

The distance G between the respective support members 53 is less than each of the long side length D11 and the short side length D12 of a game card P1. Thus, in the second embodiment, as in the first embodiment, the game card P1 having reached the sorting mechanism 51 cannot pass through any of the openings Ob, but is supported by the support members 53. For example, as shown in FIG. 17, the game card P1 is supported by two or more support members 53 while being in an orientation along the vertical direction.

In addition, the distance G (a dimension of an opening Ob in the direction of the X-axis) between the respective support members 53 is greater than the diameter D2 of a game medal P2. Thus, as shown in FIG. 17, game medals P2 pass through the respective openings Ob to fall. As described above, the sorting mechanism 51 (the plurality of support members 53) according to the second embodiment includes the openings Ob each having a size less than a size (D11, D12) of a game card P1 and greater than a size (D2) of a game medal P2. In addition, the sorting mechanism 51 sorts a game card P1 from a game medal P2 by allowing only the game medal P2, which is among the game card P1 and the game medal P2, to selectively pass through.

As in the first embodiment, the driver device 64 drives the rotation axis 61; as a result, the annular body 63 rotates. The plurality of support members 53 moves in conjunction with the rotation of the annular body 63. For example, a support member 53 disposed in the conveying section of the annular body 63 moves in the direction X1 in conjunction with the rotation of the annular body 63. Thus, a game card P1 supported by a plurality of support members 53 moves in the direction X1 with each of the plurality of support members 53. In other words, the sorting mechanism 51 according to the second embodiment is used for sorting a game card P1 from a game medal P2 and for conveying the game card P1.

As described above, the conveyor mechanism 60 moves the sorting mechanism 51 in the direction of the X-axis. In addition, the expression: “the conveyor mechanism 60 is a mechanism for conveying a game card P1 supported by a plurality of support members 53 in the direction X1” may be used. It should be noted that in the above description, it is understood that the sorting mechanism 51 is an element separate from the conveyor mechanism 60; however, the sorting mechanism 51 may be interpreted as an element of the conveyor mechanism 60. In other words, the expression: the conveyor mechanism 60 includes a plurality of support members 53.

The game card P1 conveyed by the conveyor mechanism 60 reaches an end of the annular body 63 in the direction X1. The game card P1 having reached the end of the annular body 63 reaches the discharge port 164 via a conveyance path (not shown). The player can acquire the game card P1 from the discharge port 164.

The second embodiment provides the same effects as those provided by the first embodiment. In addition, according to the second embodiment, the sorting mechanism 51 is used for sorting a game card P1 from a game medal P2 and for conveying the game card P1. Thus, compared to a configuration in which sorting and conveying of a game card P1 are realized by separate mechanisms (for example, the first embodiment), it is possible to simplify a configuration for sorting and conveying a game card P1. For example, according to the second embodiment, the fixed plate 52 and the plurality of press members 65 according to the first embodiment can be omitted.

### Third Embodiment

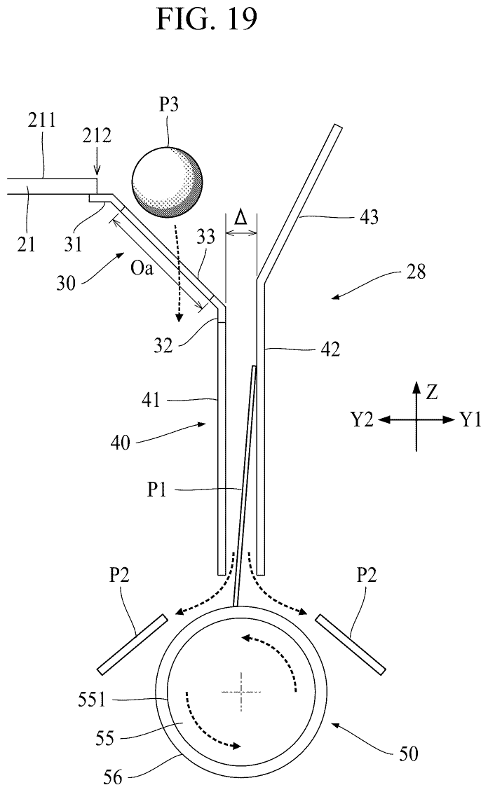

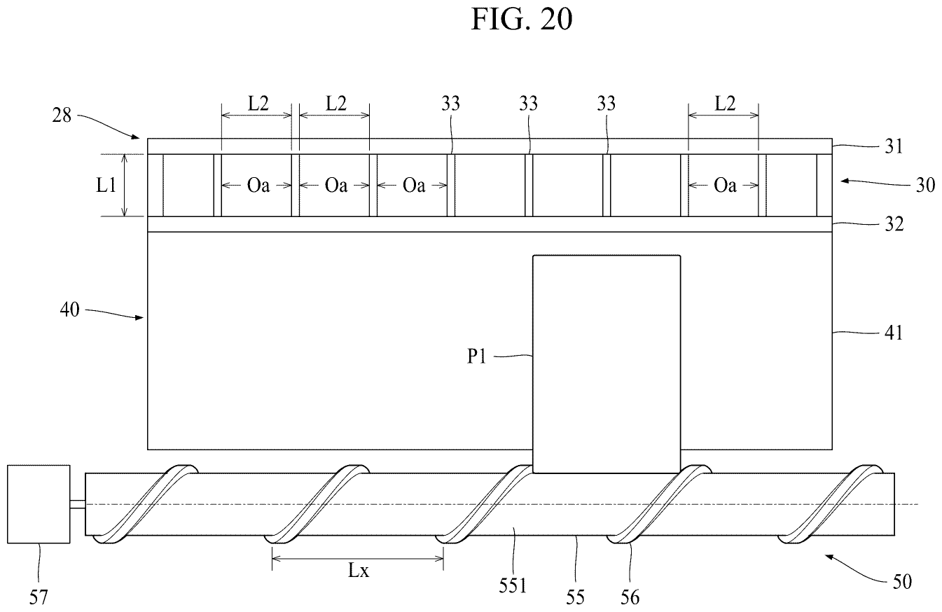

FIG. 19 is a side view of a handling mechanism 28 according to a third embodiment. FIG. 20 is a front view of the handling mechanism 28. In the third embodiment, a configuration of the sorter 50 differs from that of each of the first embodiment and the second embodiment. Elements other than the sorter 50 are the same as those of the first embodiment.

The sorter 50 according to the third embodiment includes a cylinder member 55, a protrusion 56, and a driver device 57. The cylinder member 55 is a cylindrical structure. The cylinder member 55 is provided such that a central axis of the cylinder member 55 is along the X-axis. Specifically, the cylinder member 55 extends over the entire portion of the playing field 211 that is along the direction of the X axis (i.e., the full width). The cylinder member 55 is provided directly below the guide 40. Specifically, as shown in FIG. 19 and FIG. 20, an outer circumferential surface 551 of the cylinder member 55 faces a lower end of each of the first wall member 41 and the second wall member 42 across a space.

The protrusion 56 is a spiral protrusion provided on the outer circumferential surface 551 of the cylinder member 55. The protrusion 56 is provided over the entire cylinder member 55 in a longitudinal direction and protrudes radially outwardly from the outer circumferential surface 551. It should be noted that a cycle Lx of a spiral constituting the protrusion 56 may be freely selected and may be set to a dimension greater than the short side length D12 of a game card P1, for example.

The driver device 57 rotates the cylinder member 55 about the central axis. The driver device 57 is constituted of an electric motor, for example.

As shown in FIG. 19, a distance between the outer circumferential surface 551 of the cylinder member 55 and the lower end of each of the first wall member 41 and the second wall member 42 is greater than a thickness of a game medal P2. Thus, as shown in FIG. 19, a game medal P2 falls between the first wall member 41 and the second wall member 42 to reach the sorter 50, and then passes through a space between the outer circumferential surface 551 of the cylinder member 55 and either the first wall member 41 or the second wall member 42. The game medal P2 that has passed through the sorter 50 in the path described above is detected by the detection device 27.

On the other hand, as shown in FIG. 19 and FIG. 20, when a game card P1 falls between the first wall member 41 and the second wall member 42 to reach the sorter 50, a lower end of the game card P1 is in contact with the outer circumferential surface 551. In a state in which the lower end of the game card P1 is in contact with the outer circumferential surface 551, an upper end of the game card P1 is in contact with the first wall member 41 or the second wall member 42; thus, it is possible to prevent the game card P1 from further inclining. Consequently, the game card P1 does not fall though the space between the outer circumferential surface 551 of the cylinder member 55 and either the first wall member 41 or the second wall member 42. As described above, the distance Δ between the first wall member 41 and the second wall member 42, together with the distance between the outer circumferential surface 551 of the cylinder member 55 and the lower end of each of the first wall member 41 and the second wall member 42, is set such that a game card P1 is held on the cylinder member 55 in a state in which the game card P1 is in contact with the outer circumferential surface 551.

In the state described above, when the cylinder member 55 rotates, the game card P1 is pressed by the spiral protrusion 56 to be moved in the direction X1 (i.e., a direction of the central axis of the cylinder member 55). The game card P1 finally reaches an end of the cylinder member 55 in the direction X1. After reaching the end of the cylinder member 55, the game card P1 reaches the discharge port 164 via a conveyance path (not shown). The player can acquire the game card P1 from the discharge port 164.

The third embodiment provides the same effects as those provided by the first embodiment. In addition, according to the third embodiment, a game medal P2 passes between the outer circumferential surface 551 of the cylinder member 55 and the lower end of either the first wall member 41 or the second wall member 42, and a game card P1 is in contact with the outer circumferential surface 551 of the cylinder member 55. Based on the difference described above, the game card P1 is sorted from the game medal P2. In addition, the game card P1 is conveyed by the spiral protrusion 56 in the direction (specifically, the direction X1) of the central axis of the cylinder member 55. In other words, in the third embodiment, the cylinder member 55 is used for sorting the game card P1 from the game medal P2 and for conveying the game card P1. Thus, compared to a configuration in which sorting and conveying of a game card P1 are realized by separate mechanisms, it is possible to simplify a configuration for sorting and conveying a game card P1.

### Fourth Embodiment

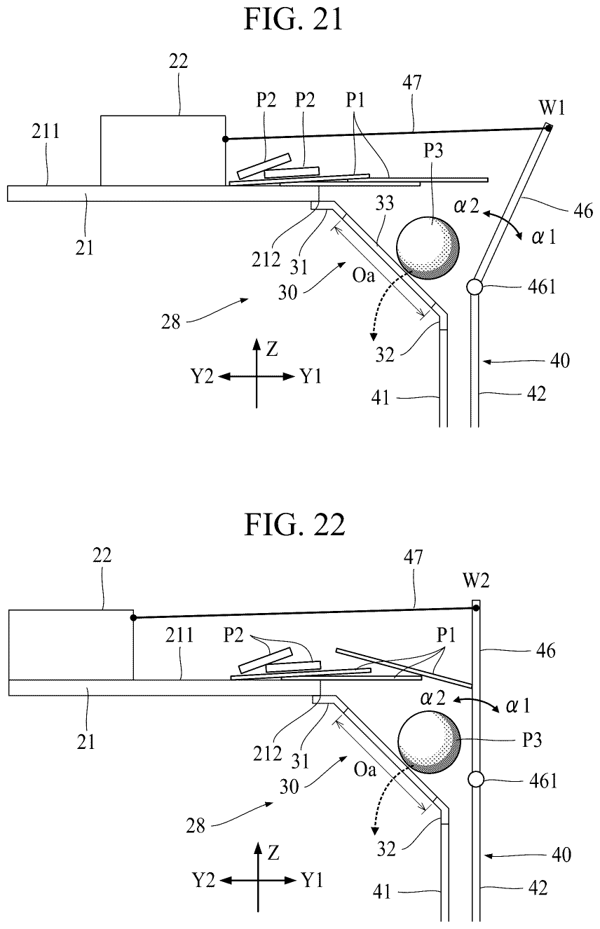

FIG. 21 and FIG. 22 are side views of a handling mechanism 28 according to a fourth embodiment. The handling mechanism 28 according to the fourth embodiment includes a movable member 46 and a connecting member 47, in place of the third wall member 43 according to the first embodiment.

The movable member 46 is a plate-shaped member extending over the entire portion of the playing field 211 that is along the direction of the X-axis (i.e., the full width). The movable member 46 is provided spaced apart from the tip end 212 of the playing field 211. A lower end of the movable member 46 is connected to the upper end of the second wall member 42 via a rotation axis 461 that is along the X-axis. The movable member 46 is rotatable about the rotation axis 461. It should be noted that the movable member 46 may be described as a member obtained by changing the third wall member 43 according to the first embodiment into a structure rotatable relative to the second wall member 42.

A distance between the lower end of the movable member 46 and the sorter 30 (for example, the horizontal shaft 32) is less than the diameter D3 of a game ball P3. Thus, the game ball P3 cannot pass through a space between the movable member 46 and the sorter 30. For example, when the game ball P3 dropped from the playing field 211 collides with the movable member 46, a direction of travel is changed and the game ball P3 passes through an opening Oa to fall. On the other hand, a game card P1 and a game medal P2 pass through the space between the movable member 46 and the sorter 30 to reach the guide 40. As will be understood from the above description, the movable member 46 functions as a stopper for preventing a game ball P3 from passing through the guide 40.

The connecting member 47 is a member (a link) connecting the movable table 22 to the movable member 46. Specifically, a plurality of connecting members 47 are provided at different locations in the direction of the X-axis. In the configuration described above, the movable member 46 is moved (rotated and moved) in conjunction with reciprocation of the movable table 22 along the direction of the Y-axis.

Specifically, with movement of the movable table 22 in the direction Y1, the movable member 46 is rotated in a direction α1 shown in FIG. 21 and FIG. 22. In a state in which the movable table 22 reaches an end of a reciprocation range in the direction Y1, the movable member 46 reaches a position W1 shown in FIG. 21. The position W1 is a position sufficiently spaced from the tip end 212 of the playing field 211.

On the other hand, with movement of the movable table 22 in the direction Y2, the movable member 46 is rotated in a direction α2 shown in FIG. 21 and FIG. 22. In a state in which the movable table 22 reaches an end of the reciprocation range in the direction Y2, the movable member 46 reaches a position W2 shown in FIG. 22. The position W2 is a location closer to the tip end 212 than the position W1. As described above, the movable member 46 moves in conjunction with reciprocation of the movable table 22 to reciprocate between the position W1 and the position W2. It should be noted that the position W1 is an example of a “first position,” and the position W2 is an example of a “second position.”

As shown in FIG. 21, in a state in which a plurality of game objects P is stacked in the playing field 211, even when actually protruding sufficiently in the direction Y1 from the tip end 212, a game card P1 may not fall from the playing field 211 by being held by other game objects P.

In the state described above, as shown in FIG. 22, with movement of the movable member 46 from the position W1 to the position W2, the game card P1 is pressed by the movable member 46. According to the fourth embodiment, by a press due to the movable member 46, it is possible to cause the game card P1 to fall. Specifically, by the movable member 46 pressing the game card P1 that protrudes sufficiently in the direction Y1 from the tip end 212, a state of the plurality of stacked game objects Pis changed; as a result, the game card P1 falls. As described above, the movable member 46 is used for limiting movement of a game ball P3 and for promoting a fall of a game card P1.

As described above, according to the fourth embodiment, in a configuration in which the movable member 46 is connected to the movable table 22 by the connecting member 47, the movable member 46 is moved in conjunction with reciprocation of the movable table 22. Thus, compared to a configuration in which the movable member 46 is moved by a driving device separate from a driver device for causing the movable table 22 to reciprocate, it is possible to simplify the configuration of the game system 100. However, the movable member 46 may be moved by the driving device separate from the driver device for causing the movable table 22 to reciprocate.

It should be moted that in the fourth embodiment, a configuration of the sorter 50 is freely selected. In other words, the sorter 50 in each of configurations described in the first embodiment to the third embodiment may be applied to the fourth embodiment.

Furthermore, in FIG. 21 and FIG. 22, a configuration is described in which the movable member 46 is connected to the second wall member 42; however, a structure in which the movable member 46 is provided is not limited to the above example. For example, in a configuration in which a game card P1 and a game medal P2 cannot enter between the second wall member 42 and the movable member 46, the movable member 46 may be provided at a position spaced apart from the second wall member 42. In other words, a gap may be provided between the upper end of the second wall member 42 and the lower end of the movable member 46.

### Fifth Embodiment

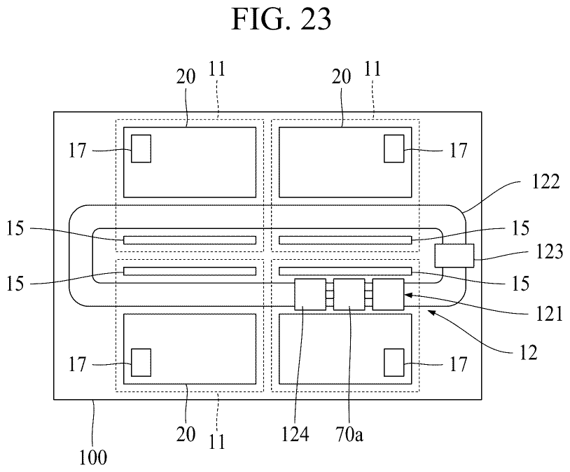

FIG. 23 is a plan view of a game system 100 according to a fifth embodiment. As shown in FIG. 23, in the game system 100 according to the fifth embodiment, a benefit device 17 is provided in each of the multiple stations 11. The benefit device 17 is a device for giving benefits to a player. Specifically, the benefit device 17 gives the player a predetermined number of benefit tickets. It should be noted that a single benefit device 17 may be provided for the multiple stations 11.

The player can acquire different types of game cards P1 by playing the game system 100. For example, the player can acquire different types of game cards P1 on which different images are drawn. In a game card P1, identification information indicative of a type of game card P1 is recorded. For example, the identification information is recorded in a storage circuit such as an IC tag provided in the game card P1. Thus, a relationship in which game cards P1 differ in type may be expressed as a relationship in which pieces of identification information differ. It should be noted that the identification information may be recorded in the game card P1 in a manner of drawing an optically readable image such as a barcode or a QR code (registered trademark), for example.

When the player acquires a predetermined number of types (for example, five types) of game cards P1, the benefit device 17 according to the fifth embodiment gives the player benefit tickets. The player inserts game cards P1 obtained by the player into an insertion port of the benefit device 17 sequentially. The benefit device 17 reads identification information from each of the game cards P1 to determine whether the number of types of game cards P1 is greater than or equal to a predetermined threshold. When the number of types is greater than or equal to the threshold, the benefit device 17 discharges a predetermined number of benefit tickets to the player. On the other hand, when the number of types of game cards P1 is less than the predetermined value, the benefit device 17 informs the player of shortage of the number of types without discharging benefit tickets.

Elements other than the benefit device 17 are the same as those of the first embodiment. Thus, the fifth embodiment provides the same effects as those provided by the first embodiment. In addition, according to the fifth embodiment, a benefit is given to a player who has acquired the predetermined number of types of game cards P1. Thus, it is possible to give a player incentives to continue the game so as to acquire the predetermined number of types of game cards P1.

### Modifications

Examples of specific modifications that may be added to the above embodiments will be described below. Two or more modifications freely selected from the following modifications may be appropriately combined as long as no conflict arises from such combination.

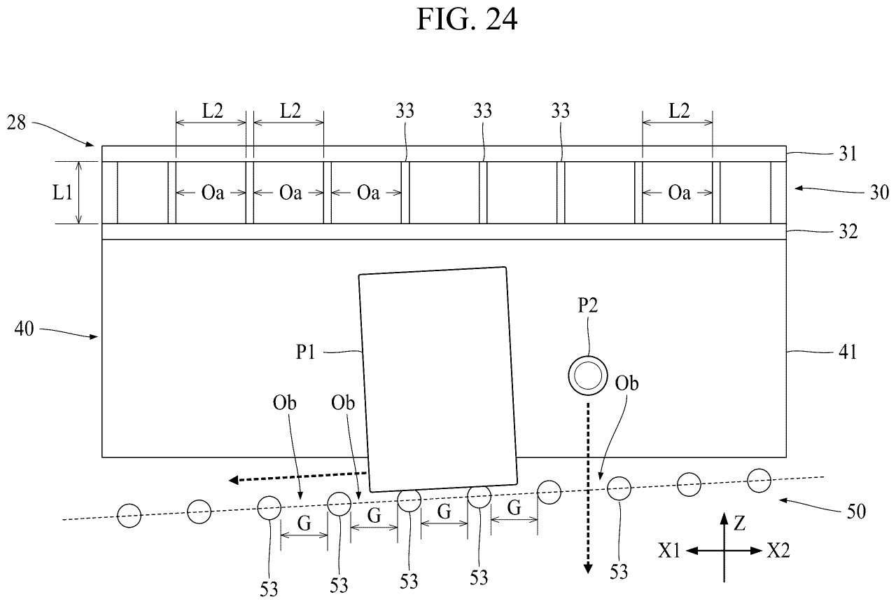

(1) A configuration of the sorter 50 is not limited to the configuration described in each of the foregoing embodiments. For example, as shown in FIG. 24, the sorter 50 may be constituted of the plurality of support members 53. The plurality of support members 53 are aligned spaced apart from one another along a straight line inclined relative to the horizontal plane. Specifically, a vertical position of each of the plurality of support members 53 is set such that a support member 53 disposed at an end of the plurality of support members 53 in the direction X1, is lower than a support member 53 disposed at an end of the plurality of support members 53 in the direction X2. As in the first embodiment, a game medal P2 falls through a space (an opening Ob) between the respective support members 53.

On the other hand, a game card P1 is supported by the plurality of support members 53. The game card P1 moves in the direction X1 along a slope of the array of the plurality of support members 53. According to the configuration described above, it is possible to move the game card P1 to the discharge port 164 by a simple configuration. It should be noted that movement of the game card P1 may be promoted by vibrating the plurality of support members 53.

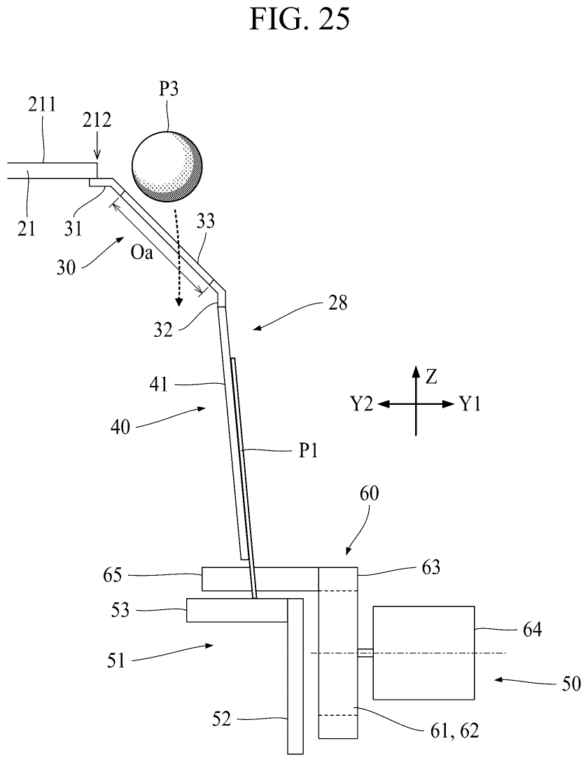

(2) In each of the foregoing embodiments, a configuration is described in which the guide 40 includes the first wall member 41 and the second wall member 42; however, a configuration of the guide 40 is not limited to the above example. For example, as shown in FIG. 25, the second wall member 42 may be omitted. In a configuration shown in FIG. 25, the first wall member 41 is provided in a state of being inclined relative to the vertical direction. A game card P1 and a game medal P2 reach the guide 40 to fall along a slope of the first wall member 41 while being contact with the first wall member 41. In other words, similarly to the guide 40 in each of the foregoing embodiments, the guide 40 shown in FIG. 25 functions as a guide for limiting an orientation of each of the game card P1 and the game medal P2 to an orientation along the vertical direction.

(3) In each of the foregoing embodiments, a configuration is described in which a game ball P3 is sorted by the sorter 30; however, the sorter 50 may be used to sort the game ball P3. For example, a configuration is assumed in which the distance Δ between the first wall member 41 and the second wall member 42 of the guide 40 is greater than the diameter D3 of the game ball P3. Similarly to a game card P1 and a game medal P2, a game ball P3 falls from the playing field 211 to fall between the first wall member 41 and the second wall member 42. Similarly to the game medal P2, the game ball P3 reaches the sorter 50 to fall through an opening Ob between the respective support members 53. According to the configuration described above, it is possible to sort a game card P1 among a plurality of game objects P. In the configuration in which the sorter 50 sorts a game ball P3, the sorter 30 in each of the foregoing embodiments may be omitted.

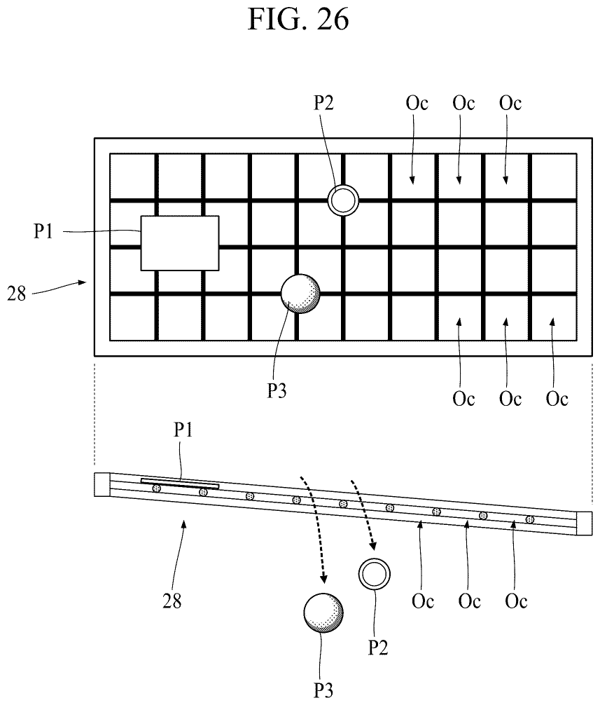

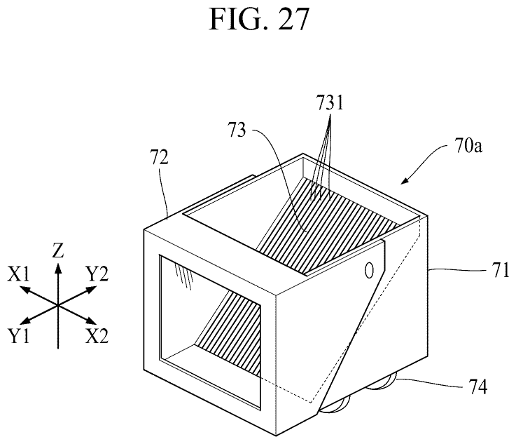

(4) A handling mechanism 28 shown in FIG. 26 may be provided in the game system 100. The handling mechanism 28 shown in FIG. 26, which is a structure in which a plurality of openings Oc are arranged in a matrix, is provided in an orientation inclined relative to the vertical direction. A plurality of game objects P dropped from the playing field 211 is placed on the handling mechanism 28.

A size of an opening Oc is less than the size of a game card P1 and is greater than the sizes of a game medal P2 and a game ball P3. Thus, the game medal P2 and the game ball P3 fall through openings Oc. On the other hand, the game card P1 cannot pass through any of the openings Oc and moves along a slope of the handling mechanism 28. Thus, it is possible to sort a game card P1 among a plurality of game objects P. It should be noted that movement of the game card P1 may be promoted by vibrating the handling mechanism 28 shown in FIG. 26.

(5) In each of the foregoing embodiments, the lid 72 is an opaque member; thus, a player cannot visually recognize game cards P1 within the accommodation mechanism 70a. As shown in FIG. 27, a portion or all of the lid 72 may be made of a transparent member. The player can visually recognize game cards P1 within the accommodation mechanism 70a via the lid 72. For example, the player can confirm game cards P1, which are desired by the player, within the accommodation mechanism 70a. Thus, it is possible to give the player incentives to continue the game.

(6) In each of the foregoing embodiments, a configuration is described in which the three types of game objects P (P1, P2, P3) are used for the game system 100; however, the number of types of game objects P is not limited to the above example. For example, the game balls P3 may be omitted.

(7) A shape of each of the game objects P is not limited to the example described in each of the foregoing embodiments. For example, a planar shape of a game card P1 or of a game medal P2 may be a shape such as a polygonal shape or an annular shape. The game medal P2 may have a shape of a lens in which a thickness of a central portion is greater than a thickness of a peripheral portion, for example. A three-dimensional shape of a game ball P3 may be a shape such as a polyhedron, for example. In addition, the three-dimensional shape of the game ball P3 may be a shape obtained by replacing corners of a type of polyhedron with curved surfaces.

(8) In each of the foregoing embodiments, a configuration is described in which the conveyor mechanism 124 conveys the accommodation mechanism 70a and the accommodation mechanism 70b to each of the multiple stations 11; however, the accommodation mechanism 70a, the accommodation mechanism 70b, and the feeding device 123 may be provided for each of the multiple stations 11 individually.

(9) In each of the foregoing embodiments, a configuration is described in which the game system 100 is provided in a real space; however, the game system 100 may be realized as a virtual object placed in a virtual space realized by arithmetic processing. Thus, for example, an information device such as a smartphone or a tablet terminal may provide a service similar to that provided by the game system 100 in the foregoing embodiments. For example, a game similar to that provided by the game system 100 may be realized as an application game provided by a program executed by the information device or as a cloud game provided by a server communicable with the information device.

(10) In this disclosure, reference to an element using the designations “first,” “second,” etc., is used only for convenience in distinguishing elements, and has no substantive meaning. Thus, a position of each of an element, an order of manufacture of the elements, etc., are not limited by a reference to an element using the designations “first,” “second,” etc.

### Supplemental Notes

For example, this disclosure is understood as follows based on the above descriptions. It should be noted that in the following descriptions, reference signs in the drawings are denoted in parentheses for convenience in order to facilitate understanding of each aspect, but this disclosure is not limited to the aspects illustrated in the drawings.

### Supplemental Note A

In a game in which different types of game objects are used, it is necessary to sort each game object. In a technique disclosed in Non-Patent Document 1, since medals and cards dropped from a table are conveyed in a horizontal direction to be sorted, it takes a long time for the cards to be discharged from a discharge port so as to be allowed to be acquired by a player, for example. In view of the circumstances described above, an object of an aspect (supplement note A) of this disclosure is to sort different types of game objects promptly.

### Supplemental Note A1

To solve the above problems, a game system (100) according to an aspect (supplemental note A1) of this disclosure includes a playing field (211) on which a plate-shaped first game object (P1) and a plate-shaped second game object (P2) differing in shape from the first game object (P1) are to be placed, a guide (40) configured to cause the first game object (P1) and the second game object (P2) dropped from the playing field (211) to fall in an orientation along a vertical direction, and a first sorter (50) provided in a path through which the first game object (P1) and the second game object (P2) fall under guidance of the guide (40) and configured to prevent the first game object (P1) from falling and allow the second game object (P2) to pass through.

According to the aspect described above, although the first game object (P1) and the second game object (P2) fall in the orientation along the vertical direction, the first game object (P1) is sorted separately by the first sorter (50) from the second game object (P2). Thus, compared to a configuration in which the first game object (P1) and the second game object (P2) are conveyed in the horizontal direction to be sorted separately, it is possible to sort the first game object (P1) from the second game object (P2) promptly. In addition, in the orientation along the vertical direction, the first game object (P1) is sorted from the second game object (P2); thus, it is possible to reduce a probability that the second game object (P2) may be placed on the first game object (P1), for example. Thus, compared to a configuration in which the first game object (P1) and the second game object (P2) fall in an orientation along a horizontal direction, it is possible for the first sorter (50) to sort the first game object (P1) from the second game object (P2) with high accuracy.

A “game object” is a freely selected object that is to be used for a game. A “shape” of the game object means a feature of an outer shape of the game object (for example, a shape defined by the outline). A “difference in shape” includes not only a case of a difference in outer shape of game object, but also a case of a similarity in outer shape but a difference in dimension. The first game object (P1) is a rectangle card, for example, and the second game object (P2) is a disc-shaped coin (medal), for example.

A “shape of a plate” means a shape in which a dimension in a direction (hereinafter referred to as an “in-plane direction”) in a surface perpendicular to a specific direction (a thickness direction) is sufficiently greater than a dimension in the specific direction, and has a concept that includes not only a shape in which a thickness that can cause the shape to be maintained alone is ensured, but also a shape of a flexible sheet or a shape of a film.

The “orientation along the vertical direction” means that an in-plane direction of a game object is closer to the vertical direction than to the horizontal direction. Specifically, a state in which an angle of the in-plane direction of the game object relative to the vertical direction is 45° or less (more particularly 30° or less) corresponds to the “orientation along the vertical direction.”

The game system (100) may be realized by a computer system provided in the real space or may be realized by a virtual object provided in a virtual space realized by arithmetic processing. In other words, an information device such as a smartphone or a tablet terminal provides a service similar to that provided by the game system (100) according to this disclosure, for example.

### Supplemental Note A2

In a specific example (supplemental note A2) of the supplemental note A1, a size of the first game object (P1) is greater than a size of the second game object (P2), and the first sorter (50) includes a sorting mechanism (51) including an opening (Ob) having a size less than the size of the first game object (P1) and greater than the size of the second game object (P2). According to the aspect described above, the first game object (P1) is sorted from the second game object (P2) depending on whether there is a size allowed to pass through an opening (Ob). Thus, by a simple configuration in which power is not required, it is possible to sort the first game object (P1) from the second game object (P2) with high accuracy.

A “size” of a game object means an outer dimension of the game object. The outer dimension is a dimension of a side (a long side or a short side) of a virtual rectangle circumscribing the game object in plan view. Specifically, a relationship in which the size of the first game object (P1) is greater than the size of the second game object (P2) is a relationship in which a minimum value of outer dimensions of the first game object (P1) is greater than a minimum value of outer dimensions of the second game object (P2) and a maximum value of the outer dimensions of the first game object (P1) is greater than a maximum value of the outer dimensions of the second game object (P2), for example.

### Supplemental Note A3

In a specific example (supplemental note A3) of the supplemental note A2, a discharge port (164) configured to discharge the first game object (P1) is further included, and the first sorter (50) further includes a conveyor mechanism (60) configured to convey, for the discharge port (164) in a direction intersecting the vertical direction, the first game object (P1) prevented from falling by the sorting mechanism (51). According to the aspect described above, the first game object (P1) prevented by the first sorter (50) is conveyed by the conveyor mechanism (60) for the discharge port (164). Thus, it is possible to discharge the first game object (P1) to the discharge port (164) promptly.

The “discharge port (164)” is an opening for discharging a game object such that a player can acquire the game object, for example. “For the discharge port (164)” means a direction in which a game object approaches the discharge port (164) along a path in which the game object moves from the playing field (211) to the discharge port (164).

### Supplemental Note A4

In a specific example (supplemental note A4) of the supplemental note A3, the sorting mechanism (51) includes a plurality of support members (53) configured to support the first game object (P1) from below, and the opening (Ob) is disposed between the plurality of support members (53). According to the aspect described above, by a simple configuration in which the plurality of support members (53) is provided spaced apart from one another, it is possible to form the opening (Ob) for sorting the first game object (P1) from the second game object (P2).

### Supplemental Note A5

In a specific example (supplemental note A5) of the supplemental note A4, the sorting mechanism (51) includes a support member (53) configured to support the first game object (P1) from below, the conveyor mechanism (60) includes a press member (65) configured to press, for the discharge port (164), the first game object (P1) supported by the support member (53), and a vertical interval between the support member (53) and the press member (65) is less than a minimum value of outer dimensions of the first game object (P1). According to the aspect described above, a distance between the support member (53) and the press member (65) is less than the minimum value of the outer dimensions of the first game object (P1). Thus, even in a state in which the first game object (P1) in an orientation in which a long side thereof faces in the horizontal direction is supported by the support member (53), the first game object (P1) can be reliably pressed by the press member (65), for example.

### Supplemental Note A6

In a specific example (supplemental note A6) of the supplemental note A2, the first sorter (50) includes a conveyor mechanism (60) configured to move the sorting mechanism (51) in a direction intersecting the vertical direction. According to the aspect described above, the sorting mechanism (51) is used for sorting the first game object (P1) from the second game object (P2) and for conveying the first game object (P1). Thus, compared to a configuration in which sorting and conveying are realized by separate mechanisms (the sorting mechanism (51), the conveyor mechanism (60)), it is possible to simplify a configuration for sorting and conveying the first game object (P1).

### Supplemental Note A7

In a specific example (supplemental note A7) of the supplemental note A1, the guide (40) includes a wall member (41) along the vertical direction, the first sorter (50) includes a cylinder member (55) having an outer circumferential surface facing a lower end of the wall member (41) across a space, the outer circumferential surface being provided with a spiral protrusion (56), and a driver device (57) configured to rotate the cylinder member (55) about a central axis of the cylinder member (55), the second game object (P2) passes through the space between the lower end of the wall member (41) and the outer circumferential surface (551) of the cylinder member (55), and the first game object (P1) is moved by the protrusion (56) in a direction of the central axis while being in contact with the outer circumferential surface (551) of the cylinder member (55). According to the aspect described above, the second game object (P2) passes between the lower end of the wall member (41) and the outer circumferential surface (551) of the cylinder member (55), and the first game object (P1) is sorted from the second game object (P2) due to the first game object (P1) being contact with the outer circumferential surface (551) of the cylinder member (55). In addition, the first game object (P1) is conveyed by the spiral protrusion (56) in the direction of the central axis of the cylindrical member (55). In other words, the cylindrical member (55) is used for sorting the first game object (P1) from the second game object (P2) and for conveying the first game object (P1). Thus, compared to a configuration in which sorting and conveying are realized by separate mechanisms (the sorting mechanism (51), the conveyor mechanism (60)), it is possible to simplify a configuration for sorting and conveying the first game object (P1).

### Supplemental Note A8

In a specific example (supplemental note A8) that is any one of the supplemental note A1 to the supplemental note A7, a third game object (P3) differing in shape from the first game object (P1) and from the second game object (P2) is to be placed on the playing field (211), and a second sorter (30) is further included that is provided between the playing field (211) and the guide (40) and is configured to sort the first game object (P1) of a plurality of game objects (P) dropped from the playing field (211) from the third game object (P3) of the plurality of game objects. According to the aspect described above, it is possible to sort the first game object (P1) from the second game object (P2); in addition, it is possible to sort the first game object (P1) from the third game object (P3). Thus, it is possible to realize a variety of games in which the first game object (P1) to the third game object (P3) are used.

### Supplemental Note A9

In a specific example (supplemental note A9) of the supplemental note A8, the second sorter (30) is configured to prevent the first game object (P1) from falling and allow the third game object (P3) to pass through. It should be noted that the second sorter (30) may allow the second game object (P2) and the third game object (P3) to pass through, for example. In other words, some of second game objects (P2) dropped from the playing field (211) pass through the second sorter (30), and the remainder pass through the guide (40) to reach the first sorter (50).

### Supplemental Note A10

In a specific example (supplemental note A10) of the supplemental note A8 or the supplemental note A9, a size of the third game object (P3) is less than a size of the first game object (P1), and the second sorter (30) includes an opening (Oa) having a size less than the size of the first game object (P1) and greater than the size of the third game object (P3). According to the aspect described above, the first game object (P1) is sorted from the third game object (P3) depending on whether it is of a size allowed to pass through an opening (Oa). Thus, by a simple configuration in which power is not required, it is possible to sort the first game object (P1) from the third game object (P3) with high accuracy.

### Supplemental Note A11

In a specific example (supplemental note A11) that is any one of the supplemental note A1 to the supplemental note A10, a fixed table (21) including the playing field (211) and a movable table (22) configured to reciprocate on the playing field (211) are further included, and the first game object (P1) and the second game object (P2) placed on the playing field (211) are pressed by the movable table (22) to fall from a tip end (212) of the playing field (211). According to the aspect described above, it is possible to realize a game (a pusher game) in which the first game object (P1) and the second game object (P2) are dropped from the playing field (211) by reciprocation of the movable table (22).

### Supplemental Note A12

In a specific example (supplemental note A12) of the supplemental note A11, a movable member (46) provided spaced apart from the tip end (212) and a connecting member (47) connecting the movable table (22) to the movable member (46) are further included, and the movable member (46) is configured to reciprocate between a first position (W1) that is away from the tip end (212) and a second position (W2) closer to the tip end (212) than the first position (W1) by moving in conjunction with reciprocation of the movable table (22) by way of the connecting member (47). According to the aspect described above, the first game object (P1) maintained in a state of protruding from the tip end (212) of the playing field (211) can be pressed by the movable member (46) to fall from the playing field (211). In other words, it is possible to cause the first game object (P1), which protrudes sufficiently from the tip end (212) of the playing field (211) but does not yet fall from the playing field (211), to be fall from the playing field (211). Furthermore, in a configuration in which the movable member (46) is connected to the movable table (22) by the connecting member (47), the movable member (46) is moved in conjunction with reciprocation of the movable table (22). Thus, compared to a configuration in which the movable member (46) is moved by a driving device separate from a driver device for causing the movable table (22) to reciprocate, it is possible to simplify the configuration of the game system (100).

### Supplemental Note B

In a game in which game objects such as game cards are used, for the purpose of effect, it is required to discharge a plurality of game objects from an accommodation mechanism to a wide range of a playing field, for example. However, for example, in a configuration in which a plurality of game cards in different orientations are accommodated within an accommodation mechanism, it is difficult to forcefully discharge the plurality of game cards to a wide range. In view of the circumstances described above, an object of an aspect (supplement note B) of this disclosure is to forcefully discharge a plurality of game cards to a wide range of a playing field.

### Supplemental Note B1

To solve the above problems, a game system (100) according to an aspect (supplemental note B1) of this disclosure includes a controller (13) configured to control progress of a game, an accommodation mechanism (70a, 70b) configured to accommodate a plurality of game cards (P1), and a feeding device (123) configured to feed game cards (P1) to the accommodation mechanism (70a, 70b) in accordance with the progress of the game, wherein the accommodation mechanism (70a, 70b) is controlled between an accommodation state in which the plurality of game cards (P1) is held in the same orientation and a discharge state in which the plurality of game cards (P1) are discharged to a playing field (211). According to the aspect described above, in the accommodation state, the plurality of game cards (P1) in the same orientation are accommodated within the accommodation mechanism (70a, 70b), and in the discharge state, the plurality of game cards (P1) are discharged to the playing field (211). Thus, compared to a configuration in which the plurality of game cards (P1) in different orientations are accommodated within the accommodation mechanism (70a, 70b), it is possible to forcefully discharge the plurality of game cards (P1) to a wide range of the playing field (211), for example.

### Supplemental Note B2

In a specific example (supplemental note B2) of the supplemental note B1, in the accommodation state, the plurality of game cards (P1) is accommodated within the accommodation mechanism (70a, 70b) while being stacked in parallel to one another. According to the aspect described above, since the plurality of game cards (P1) are stacked, compared to a configuration in which the plurality of game cards (P1) are accommodated without overlapping, it is possible to reduce a size of the accommodation mechanism (70a, 70b), for example.

### Supplemental Note B3

In a specific example (supplemental note B3) of the supplemental note B2, the accommodation mechanism (70a, 70b) includes a mounting surface (73) on which the plurality of game cards (P1) is placed, and in the discharge state, the plurality of game cards (P1) are discharged along the mounting surface (73) in a state in which the mounting surface (73) is inclined relative to a horizontal plane. According to the aspect described above, the plurality of game cards (P1) stacked in parallel to one another are discharged from the accommodation mechanism (70a, 70b) along the mounting surface (73) inclined relative to the horizontal plane. Thus, a game card (P1) slides on an upper surface of another game card (P1); thus, it is possible to spread the plurality of game cards (P1) over a wide range.

### Supplemental Note B4

In a specific example (supplemental note B4) of the supplemental note B3, in the discharge state, the mounting surface (73) is inclined such that an end of the mounting surface (73) close to a player is lower than an opposing end of the mounting surface (73). According to the aspect described above, it is possible to spread the plurality of game cards (P1) to an area close to the player in a wide range.

### Supplemental Note B5

In a specific example (supplemental note B5) that is any one of the supplemental note B1 to the supplemental note B4, a plurality of stations (11) each including the playing field (211), and a conveyor mechanism (124) configured to convey the accommodation mechanism (70a, 70b) to each of the plurality of stations (11) are further included. According to the aspect described above, since the accommodation mechanism (70a, 70b) is conveyed to each of the plurality of stations (11), it is unnecessary to provide the accommodation mechanism (70a, 70b) for each of a plurality of playing fields (211) individually. Thus, it is possible to simplify a configuration of the game system (100).

### Supplemental Note B6

In a specific example (supplemental note B6) that is any one of the supplemental note B1 to the supplemental note B5, the game is a game in which a player acquires game cards (P1), and a benefit device (17) configured to give a benefit to the player when the player acquires a predetermined number of types of game cards (P1) is further included. According to the aspect described above, the benefit is given to the player who has acquired the predetermined number of types of game cards (P1). Thus, it is possible to give a player incentives to continue the game so as to acquire the predetermined number of types of game cards (P1).

### DESCRIPTION OF REFERENCE SIGNS

100 . . . game system, 11 . . . station, 12 . . . conveyor system, 13 . . . controller, 14 . . . storage device, 15 . . . display, 16 . . . operation unit, 17 . . . benefit device, 20 . . . game mechanism, 21 . . . fixed table, 211 . . . playing field, 212 . . . tip end, 22 . . . movable table, 221 . . . mounting surface, 23 . . . fixed wall, 24 . . . feeding mechanism, 25 . . . feeding device, 26 . . . feeding device, 27 . . . detection device, 28 . . . handling mechanism, 30 . . . sorter, 31 . . . horizontal shaft, 32 . . . horizontal shaft, 33 . . . vertical shaft, 40 . . . guide, 41 . . . first wall member, 42 . . . second wall member, 43 . . . third wall member, 46 . . . movable member, 47 . . . connecting member, 50 . . . sorter, 51 . . . sorting mechanism, 52 . . . fixed plate, 53 . . . support member, 55 . . . cylindrical member, 551 . . . outer circumferential surface, 56 . . . protrusion, 57 . . . driver device, 60 . . . conveyor mechanism, 61 . . . rotation axis, 62 . . . rotation axis, 63 . . . annular body, 64 . . . driver device, 65 . . . press member, 70 . . . accommodation mechanism, 70a, 70b . . . accommodation mechanism, 71 . . . housing, 72 . . . lid, 73 . . . mounting surface, 731 . . . groove, 74 . . . cart, 90 . . . conveyor mechanism, 91 . . . inclined surface, 93 . . . opening, 121 . . . movable body, 122 . . . conveyance path, 123 . . . feeding device, 124 . . . conveyor mechanism, 151 . . . image, 152 . . . image, 161 . . . operation device, 162 . . . reception device, 163 . . . payout device, 164 . . . discharge port, C . . . character, Oa, Ob, Oc . . . opening, P . . . game object, P1 . . . game card, P2 . . . game medal, P3 . . . game ball.

What is claimed is:

1. A game system comprising:
a playing field on which a plate-shaped first game object and a plate-shaped second game object differing in shape from the first game object are to be placed,
a guide configured to cause the first game object and the second game object dropped from the playing field to fall in an orientation along a vertical direction, and
a first sorter provided in a path through which the first game object and the second game object fall under guidance of the guide and configured to prevent the first game object from falling and allow the second game object to pass through.

2. The game system according to claim 1,
wherein a size of the first game object is greater than a size of the second game object, and
wherein the first sorter includes a sorting mechanism including an opening having a size less than the size of the first game object and greater than the size of the second game object.

3. The game system according to claim 2, further comprising:
a discharge port configured to discharge the first game object,
wherein the first sorter further includes a conveyor mechanism configured to convey, for the discharge port in a direction intersecting the vertical direction, the first game object prevented from falling by the sorting mechanism.

4. The game system according to claim 3,
wherein the sorting mechanism includes a plurality of support members configured to support the first game object from below, and
wherein the opening is disposed between the plurality of support members.

5. The game system according to claim 3,
wherein the sorting mechanism includes a support member configured to support the first game object from below,
wherein the conveyor mechanism includes a press member configured to press, for the discharge port, the first game object supported by the support member, and
wherein a vertical distance between the support member and the press member is less than a minimum value of outer dimensions of the first game object.

6. The game system according to claim 2, wherein the first sorter includes a conveyor mechanism configured to move the sorting mechanism in a direction intersecting the vertical direction.

7. The game system according to claim 1,
wherein the guide includes a wall member along the vertical direction,
wherein the first sorter includes:
a cylinder member having an outer circumferential surface facing a lower end of the wall member across a space, the outer circumferential surface being provided with a spiral protrusion; and
a driver device configured to rotate the cylinder member about a central axis of the cylinder member,
wherein the second game object passes through the space between the lower end of the wall member and the outer circumferential surface of the cylinder member, and wherein the first game object is moved by the protrusion in a direction of the central axis while being in contact with the outer circumferential surface of the cylinder member.

8. The game system according to claim 1,
wherein a third game object differing in shape from the first game object and from the second game object is to be placed on the playing field,
the game system further comprising a second sorter provided between the playing field and the guide and configured to sort the first game object of a plurality of game objects dropped from the playing field from the third game object of the plurality of game objects.

9. The game system according to claim 8, wherein the second sorter is configured to prevent the first game object from falling and allow the third game object to pass through.

10. The game system according to claim 9,
wherein a size of the third game object is less than a size of the first game object, and
wherein the second sorter includes an opening having a size less than the size of the first game object and greater than the size of the third game object.

11. The game system according to claim 1, further comprising:
a fixed table including the playing field; and
a movable table configured to reciprocate on the playing field, and
wherein the first game object and the second game object placed on the playing field are pressed by the movable table to fall from a tip end of the playing field.

12. The game system according to claim 11, further comprising:
a movable member provided spaced apart from the tip end; and
a connecting member connecting the movable table to the movable member,
wherein the movable member is configured to reciprocate between a first position that is away from the tip end and a second position closer to the tip end than the first position by moving in conjunction with reciprocation of the movable table by way of the connecting member.
